(19) United States
(12) Patent Application Publication
(10) Pub. No.: US 2015/0328082 A1
(43) Pub. Date: Nov. 19, 2015

(54) Interactive Entertainment System Having Sensory Feedback

(71) Applicant: HDFEEL Corp., Fremont, CA (US)

(72) Inventors: Li Jiang, Union City, CA (US); Ming Fu, Shenzhen (CN); Lawrence Wang, Mountain View, CA (US); LanLan Tang, Union City, CA (US)

(21) Appl. No.: 14/486,809

(22) Filed: Sep. 15, 2014

Related U.S. Application Data
(60) Provisional application No. 61/994,818, filed on May 16, 2014.
(60) Provisional application No. 62/013,486, filed on Jun. 17, 2014.

(51) Int. Cl. A61H 19/00

(52) U.S. Cl. CPC A61H 19/44; A61H 2201/501; A61H 2201/5043; A61H 2201/5048; A61H 2201/5097

(57) ABSTRACT

An interactive entertainment system comprises a display device for viewing an interactive video and a controller for operating one or more sex toys for providing stimulations to a user at a remote location and displayed in the interactive video. A sensory feedback is generated as a function of the provide stimulations. The sensory feedback indicates one or more of the following: strength of the stimulations; patterns of the stimulations; characteristics of the stimulations; status of the stimulations; types of the stimulations; and the status of the sex toys. The one or more sex toys and the controller are at different locations. The one or more sex toys can be virtual objects or real objects, while the user can be a virtual user or a natural person.

### CROSS REFERENCE

This application claims priority from the following patent applications: a provisional patent application entitled “Method, Apparatus, and System for Human Interaction” filed on May 16, 2014 and having an Application No. 61/994,818; and a provisional patent application entitled “Methods of Providing Feedback During Remote Sex Activities” filed on Jun. 17, 2014 and having an Application No. 62/013,486. Said applications are incorporated herein by reference.

### FIELD OF INVENTION

The disclosure relates to an interactive entertainment system, and, more particularly, to an interactive entertainment system that generates sensory feedback for sexual activity.

### BACKGROUND

The adult toy industry is one of the largest and most successful aspects of adult entertainment today. One particular aspect of that industry, namely the manufacture and sale of vibrators/dildos, provides a significant percentage of the sales revenue for adult toy producers. Sales of these devices top multiple millions annually, with manufacturers producing both the devices themselves as well as replacement parts and accessories all over the world.

Typically, vibrators, dildos, and other sex toys have been manufactured in a variety of shapes, with the devices being capable of a variety of pleasurable functions and/or functionalities. As is suggested by the name, most vibrators, dildos, and other sex toys are capable of vibrating and/or gyrating, while others may be capable of rotation, extension, as well as emitting an electric charge. These devices can come in a variety of shapes and sizes.

As technology has developed further, convergence of sex toys and wireless communications has led to remote controllable sex toys. Early on, remote control of a sex toy required that the sex toy and the remote controller be generally in the same vicinity, e.g., in the same room. However, as networking technologies became more common place and sophisticated, remote control sex toys can be accessed at great distances via the internet, or other data networks. In addition, the advent of the internet and video conferencing has further enabled couples to maintain long-distance relationships with a high degree of communication and intimacy by pleasuring each other using remotely enabled sex toys.

Sex toys have also been very popular in virtual sex systems, where users pleasure themselves by having virtual sex with either a virtual character on a video screen or a pornographic video using sex toys. However, the virtual sex systems, at best, only provide preset feedback to the users or no feedback at all to the users of the virtual sex systems. The preset feedback is the same for all users no matter how the users interact with the virtual sex systems. Therefore, it is desirable to develop new devices, systems, and methods that can provide custom user feedback depending on the user's preferences and the user's interactions.

In addition, remote sex systems do not provide any feedback of the status of a remote sex toy and the status of the stimulation to a user that may be remotely controlling the remote sex toy. Therefore, it is desirable to develop new devices, systems, and methods that can provide feedback of the stimulations and the status of the remote sex toy to the user to inform the user of the stimulations and the status of the sex toy.

### SUMMARY OF INVENTION

Briefly, the disclosure relates to an interactive entertainment system, comprising: a display device for viewing an interactive video; and a controller for operating one or more sex toys for providing stimulations to a user at a remote location and displayed in the interactive video, wherein a sensory feedback is generated as a function of the provided stimulations, wherein the sensory feedback indicates one or more of the following: strength of the stimulations; patterns of the stimulations; status of the stimulations; characteristics of the stimulations, types of the stimulations, status of the sex toy, wherein the one or more sex toys and the controller are at different locations. The one or more sex toys can be virtual objects or real objects, while the user can be a virtual user or a natural person.

### DESCRIPTION OF THE DRAWINGS

The foregoing and other aspects of the disclosure can be better understood from the following detailed description of the embodiments when taken in conjunction with the accompanying drawings.

FIG. 1 illustrates a diagram of an interactive entertainment system for remotely operating a sex toy.

FIG. 2 illustrates a flow chart of an interactive entertainment system for remotely operating a sex toy.

FIGS. 3a-3c illustrate diagrams of sex toys having visual feedback indicators.

FIGS. 4a-4k illustrate examples of various lighting configurations of visual feedback indicators for sex toys.

FIG. 5 illustrates a diagram of an interactive entertainment system for remotely operating a sex toy having a visual feedback indicator.

FIG. 6 illustrates another example of a diagram of an interactive entertainment system for remotely operating a sex toy, where a visual feedback indicator is provided.

FIG. 7 illustrates yet another example of a diagram of an interactive entertainment system for remotely operating a sex toy, where a visual feedback indicator is provided.

FIG. 8a illustrates a diagram of an interactive entertainment system for remotely operating a sex toy, where an audio feedback indicator is provided.

FIG. 8b illustrates a diagram of an interactive entertainment system for remotely operating a sex toy, where a haptic feedback indicator is provided.

FIGS. 9a-9b illustrate diagrams of a sex toy having detachable modules.

FIGS. 10a-10b illustrate diagrams of another embodiment of a sex toy having detachable modules.

FIGS. 11a-11b illustrate diagrams of yet another embodiment of a sex toy having a detachable rabbit device.

FIG. 12 illustrates a sex toy having distinct devices.

FIGS. 13-15 illustrate diagrams of sex toys having detachable modules.

FIGS. 16a-16b illustrate diagrams of an interactive entertainment system for engaging in virtual sexual activity.

FIG. 17 illustrates a diagram of an interactive entertainment system for engaging in remote sexual activity with another user.

FIG. 18 illustrates a diagram for data communication lines between various devices of an interactive entertainment system.

FIG. 19 illustrates a graph of user activity of an interactive entertainment system on a timeline.

FIG. 20 illustrates a diagram of a device displaying an interactive video having a privacy control setting.

FIGS. 21a-21b illustrate diagrams of other examples of a device displaying an interactive video having a privacy control setting.

FIG. 22 illustrates a flow chart of determining a privacy control to apply to an interactive video.

FIG. 23 illustrates a diagram of an interactive entertainment system having multiple cameras to record a user.

FIG. 24 illustrates a diagram of a controller having a graphical user interface to control a sex toy.

FIGS. 25-28 illustrate haptic feedbacks graphs for a sex toy.

FIGS. 29-32 illustrate diagrams of controllers having various user interfaces for selecting haptic effects of a sex toy.

FIGS. 33-34 illustrate diagrams of modular sex toys.

FIGS. 35-36 illustrate diagrams of cross sections of a sex toy that has an adjustable diameter.

FIGS. 37-40 illustrate diagrams of convertible sex toys.

FIGS. 41-43 illustrate diagrams of sex toys having one or more actuators.

FIGS. 44-47 illustrate actuator performance graphs for one or more actuators of the sex toys.

FIG. 48 illustrates a diagram of devices for an interactive entertainment system, where the devices are undergoing a setup phase.

FIG. 49 illustrates a diagram of a cross sectional view of a vagina and a sex toy partially disposed in the vagina.

### DETAILED DESCRIPTION OF THE EMBODIMENTS

In the following detailed description of the embodiments, reference is made to the accompanying drawings, which form a part hereof, and in which is shown by way of illustration of specific embodiments in which the disclosure may be practiced.

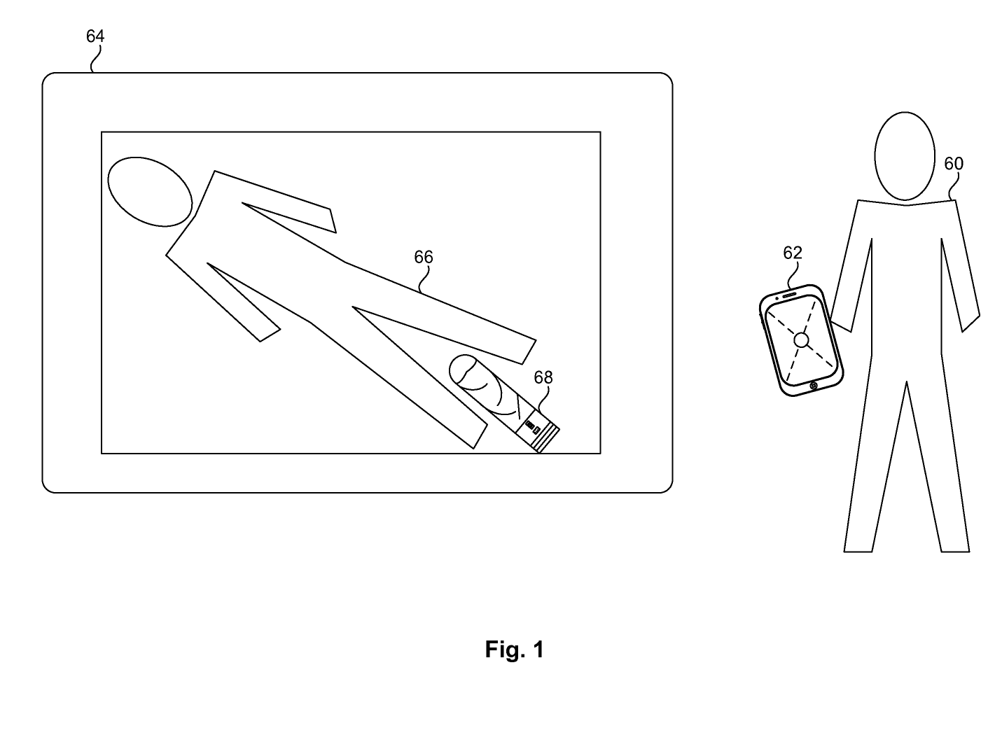

FIG. 1 illustrates a diagram of an interactive entertainment system for remotely operating a sex toy. A sex toy of the present disclosure can be a dildo, a vibrator, a wearable device (e.g., an underwear device, bra device, or other wearable device having components for providing stimulation to the wearer), and/or other devices to provide stimulation. An interactive entertainment system comprises a display device 64 (e.g., a computer screen, a laptop, a smartphone, a smart watch, a tablet, a liquid crystal display, or other electronic device having a display) for viewing an interactive video, a controller 62 (e.g., a computer, a media player, a dedicated device, a smartphone, a smart watch, a tablet, a remote controller, or other electronic device) for remotely operating a sex toy 68 in the interactive video. The display device 64 and the controller 62 can be part of the same system or device. For instance, a user can use a computer (or other computing device, including a smart phone, a tablet computer, a personal digital assistant, a laptop, a television, a gaming console, etc.) as both the display device 64 and the controller 62. The user may interact with the interactive entertainment system by inputting commands into the keyboard or by moving the mouse of the computer.

Referring to FIG. 1, the sex toy 68 can provide different types of stimulations, such as vibrational stimulation, motion stimulation, force stimulation, electric stimulation, friction stimulation, and/or other types of stimulation to a user 66. The interactive entertainment system can provide a sensory feedback to a user 60 to indicate the real time strength, pattern, and other status information of the stimulations for the sex toy 68. The sensory feedback can be visual feedback, audio feedback, and/or haptic feedback to the user 60. The sex toy 68 and the controller 62 can be at different locations. In addition, the sex toy 68 can be a virtual sex toy or a real physical device.

During remote sex activities, the user 60 controls the sex toy 68 remotely through the controller 62. The user 60 can input commands to the controller 62 to control the sex toy 68. The controller 62 can have a non-graphical interface (e.g., a gesture input, a voice input, a text input, etc.) or a graphical user interface to control the stimulation directly (e.g., by controlling the vibration amplitudes and frequencies of one or more actuators of the sex toy 68) or allow the user 60 to send predefined stimulations to the sex toy 68. The user 66 can be displayed in the interactive video. The user 66 can be a virtual character that is computer generated by the interactive entertainment system or can be another physical user in the interactive entertainment system. Privacy controls can be selected or automatically applied such that one or more areas of the user 66 or of user 66's environment can be blurred in the interactive video.

The user 60 can represent a human user and a user 66 can represent a remote partner (either a virtual partner or another human user) that the user 60 interacts with. The controller 62 can be a smart device that the user 60 uses to remotely control the sex toy 68, where the commands are routed through a data/computer network, e.g., the internet or other electronic network, from the controller 62 to the sex toy 68. The remotely located sex toy 68 can be either a physical device or a virtual device. If the display device 64 is a computer, then the user can input commands using the keyboard or other user input method of the computer to interact with the interactive video of the user 66. The commands from the controller 62 (or any other user input devices) can also be routed by the computer or by the controller 62 (if the controller has data connection capability) to the remotely located sex 68 toy via the internet or other electronic network. The controller 62 and the user 60 can be at a first location, which is remotely located from the user 66 and the sex toy 68. The user 66 and the sex toy 68 can also be virtually created, which can be also considered to be remotely located from the user 60 and the controller 62. Thus, the location can be a virtually created location or the actual location of the other user 66.

Although, the user 60 is controlling the remotely located sex toy 68, the user 60 may not have a direct sense of the motion and status of the sex toy 68. In other words, the user 60 doesn't know what the sex toy 68 is doing even though the user 60 is controlling the sex toy 68. Thus, it is important to provide the user 60 with some type of sensory feedback, so that user 60 knows about the motion and status of the sex toy 68. The interactive entertainment system can provide sensory feedback to the user 60 either through visual feedback, audio feedback, and/or haptic feedback.

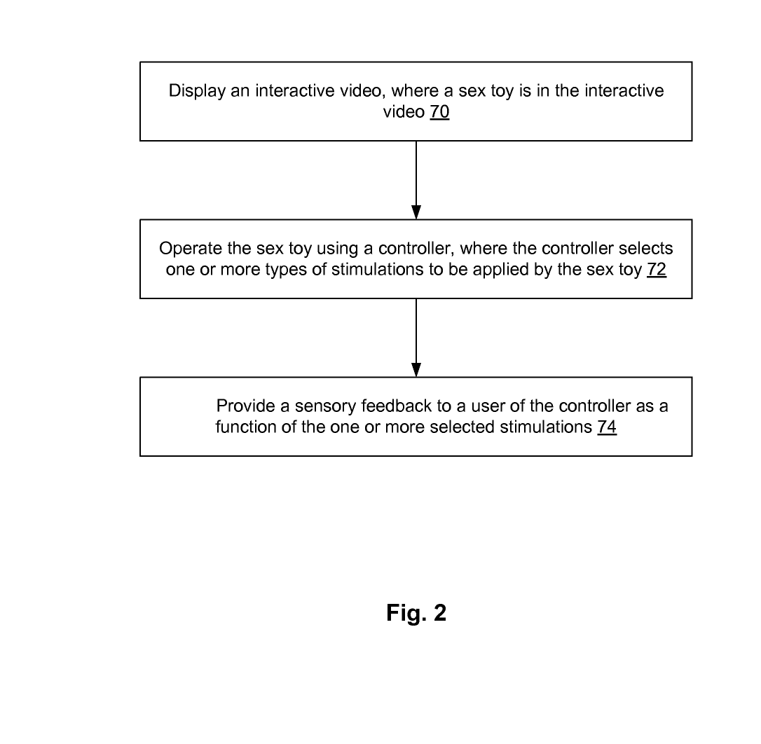

FIG. 2 illustrates a flow chart of an interactive entertainment system for remotely operating a sex toy. In a method for operating an interactive entertainment system, an interactive video is displayed on a display device 70, where a sex toy is in the interactive video and the sex toy can generate different types of stimulations to another user or virtual user. The sex toy can be operated 72 using a controller, where the controller can select one or more types of stimulations to be applied by the sex toy. The interactive entertainment system can provide a sensory feedback as a function of the selected one (or the selected ones) of the stimulations 74. Furthermore, the sex toy and the controller can be at different locations. The controller can also have a graphical user interface to control amplitudes and frequencies of one or more actuators of the sex toy.

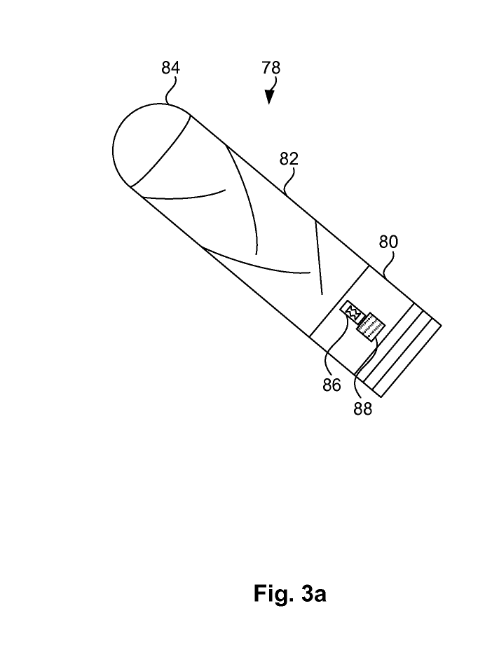

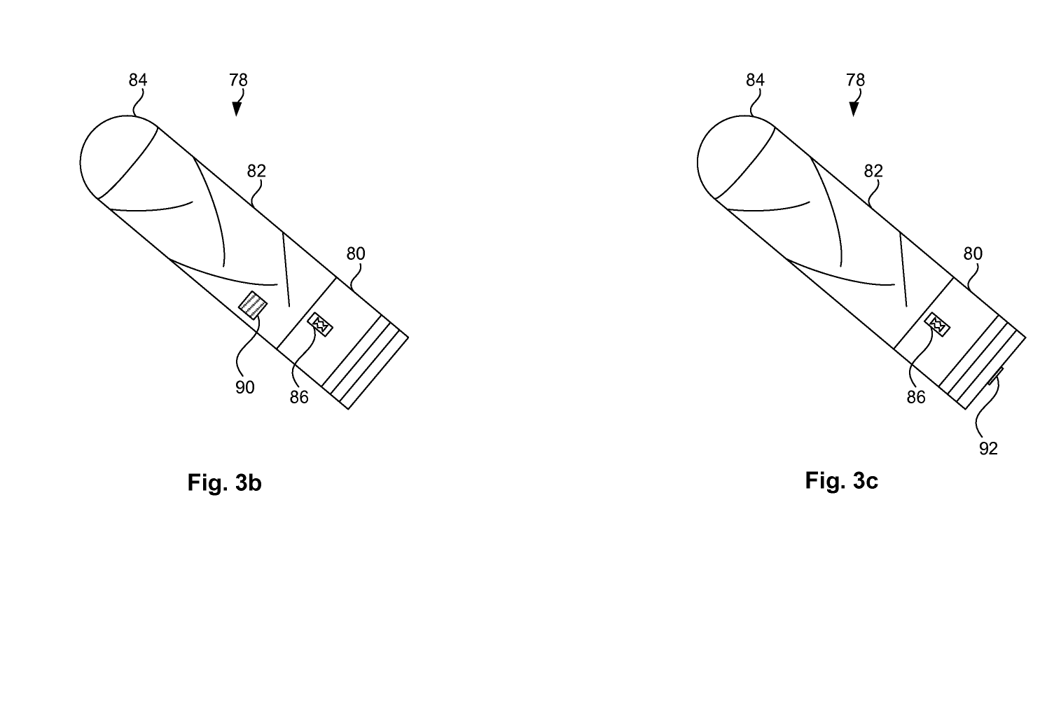

FIGS. 3a-3c illustrate diagrams of sex toys having visual feedback indicators. FIG. 3a illustrates a diagram of a sex toy having a visual feedback indicator. A sex toy 78 comprises a tip 84, a shaft 82, and a base 80. The sex toy 78 is one example of a sex toy. However, a person having ordinary skill in the art can appreciate that various other sex toy configurations exist and can be used in conjunction with the present disclosure. In particular, a sex toy can have various shapes, sizes, and functionality for providing various stimulations to a user. These other sex toy configurations can be used in conjunction with the present disclosure.

The base 80 can have a user interface 86 for selecting one or more stimulation strengths and patterns and a visual feedback indicator 88. The visual feedback indicator 88 can comprise a light source (e.g., one or more light emitting diodes (“LEDs”), or other lighting device) and can be located anywhere on the sex toy 78. The visual feedback indicator 88 provides a light pattern to visually indicate the strength, the pattern, the type, and/or other status information of the stimulations of the sex toy 78 and the status of the sex toy 78. Therefore, a user can view the light pattern from the visual feedback indicator 88 on the sex toy 78 to determine the strength, the pattern, the type, and/or other status information of the stimulations of the sex toy 78 and the status of the sex toy 78.

Visual feedback can be provided on the sex toy 78 by having components that can produce light. In an example embodiment, the visual feedback indicator can be nine LEDs in an array on the base 80 of the sex toy 78. The LEDs can be lighted to indicate a vibration status and patterns of the sex toy 78. In alternative embodiments, the sex toy 78 can have other lighting elements to implement the visual feedback indicator. For instance, the sex toy 78 can have one or more lighting elements in the sex toy 78 to light up the entire toy 78 or part of the sex toy 78.

Alternatively, the visual feedback indicator of the sex toy 78 can be located on a wired connection to the sex toy 78. This can aid a viewer of the sex toy 78 since some users prefer to insert the sex toy 78 into a bodily cavity in which the sex toy 78 may no longer be externally viewable. However, by having the visual feedback indicator located on the wired connection, a viewer can still view the visual feedback regardless of the user inserting the sex toy 78 into the bodily cavity.

The vibrational pattern of the sex toy 78 can be mapped to a pattern of light on the LEDs. The pattern of the light can indicate to a remote user (or the current user of the sex toy 78) the vibrational pattern (or other haptic pattern) of the sex toy 78. For instance, when a remote user sees the flashing of the LEDs of the sex toy 78 on a display device of the interactive entertainment system, the remote user can be notified of the operation of the sex toy 78, e.g., the exact stimulation strength and pattern for that sex toy 78.

With reference to FIG. 1 and assuming a visual feedback indicator is on the sex toy 68, the user 60 can view the visual feedback indicator of the sex toy 68 from the display device 64 during remote sex activity. While the user 66 is directly playing with the sex toy 68, the sex toy 68 is controlled by the user 60. The vibrational pattern and strength of the sex toy 68 can be mapped to a particular light pattern that is shown on the visual feedback indicator of the sex toy 68 so that the user 60 can view what vibrational pattern and strength the sex toy 68 is currently at.

FIGS. 3b and 3c illustrate alternate locations that the visual feedback indicator can be located at. The lighting elements of a visual feedback indicator can be positioned at different locations on the sex toy 78. For instance, a visual feedback indicator 90 can be positioned on the shaft 82. Also, a visual feedback indicator 90 can be positioned at the bottom of the base 80. Other positions for the visual feedback indicator are apparent based on the present disclosure. The present figures are meant to aid in the understanding of the disclosure and are not meant to be limiting since a person having ordinary skill in the art can appreciate other locations on the sex toy 78 to position the visual feedback indicator.

The sex toy 78 can further comprise one or more biometric sensors. Haptic feedback can be generated based on the biometric information. The sex toy can have embedded sensors to measure biometric information of the user, such as blood pressure, blood oxygen level, heart rate, hardness of the penis, and excitement level of the user. Those parameters can be used by the system to decide what the most suitable haptic effect for the user in his/her current state.

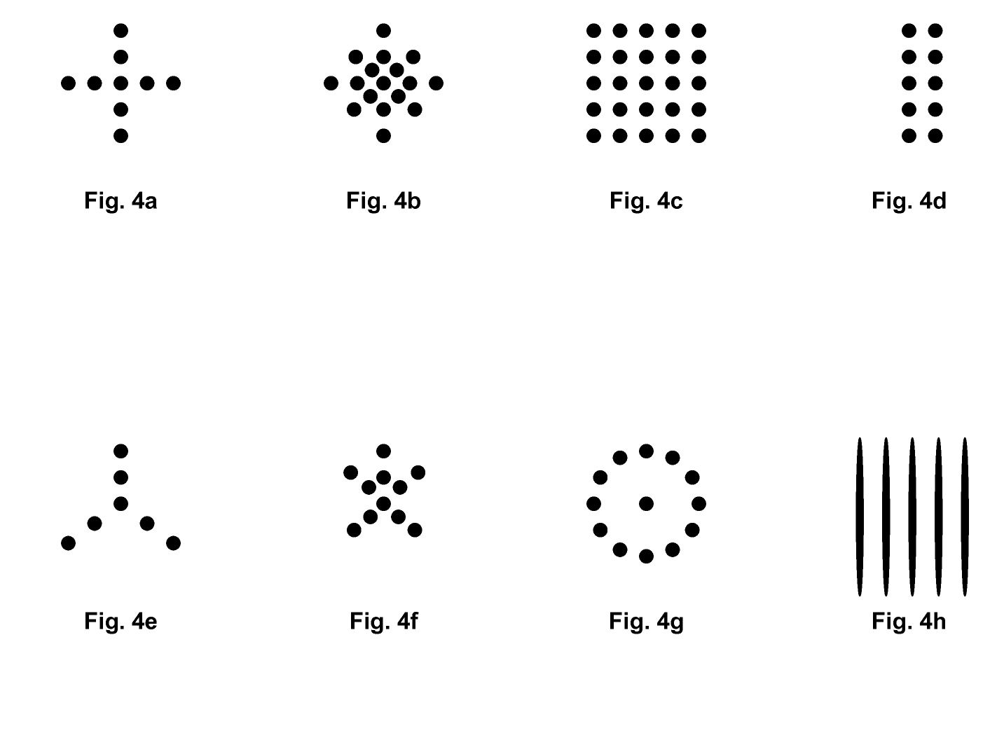

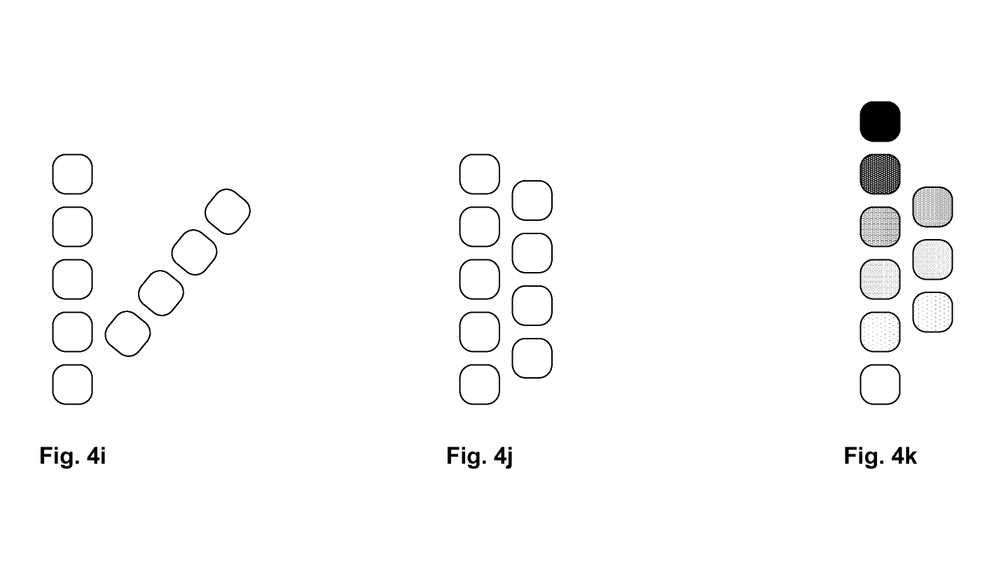

FIGS. 4a-4k illustrate various lighting configurations of visual feedback indicators for sex toys. FIG. 4a shows an LED cross shape pattern for the visual feedback indicator. FIG. 4b shows an LED cluster pattern for the visual feedback indicator. FIG. 4c shows an LED array pattern having five columns and five rows of LEDs for the visual feedback indicator. FIG. 4d shows an LED array pattern having two columns and five rows for the visual feedback indicator. FIG. 4e shows an LED pattern having three linear branches for the visual feedback indicator. FIG. 4f shows an LED pattern having five linear branches for the visual feedback indicator. FIG. 4g shows an LED circular pattern with an LED in the middle for the visual feedback indicator. FIG. 4h shows an LED pattern having five long, parallel LEDs for the visual feedback indicator. FIG. 4i illustrates two bars of lighting elements, where the bars of lighting elements are at an angle to each other. FIG. 4j illustrates two parallel bars of lighting elements. FIG. 4k illustrates another embodiment of two parallel bars of lighting elements, wherein the density, intensity, and/or color of each of the lighting elements can be adjusted for providing various lighting patterns.

The previous examples of visual feedback indictors are a sampling of forms that the visual feedback indicator may take. It is understood that other patterns can become apparent based on the present disclosure such that the lighting elements can be other shapes and in other configurations. For instance, one or more lighting elements can be embedded within a sex toy and beneath a transparent or semi-transparent layer of the sex toy (e.g., a semi-transparent silicon cover, semi-transparent rubber cover, transparent plastic sheath, or other cover or sheath of the sex toy). Thereby, the one or more lighting elements can be illuminated in unison or in various orders to change its brightness, frequency, color, density, and/or other property of the lighting elements to serve as a visual feedback indicator of the sex toy. Since the lighting elements are embedded underneath a transparent or semi-transparent layer of the sex toy, a portion or the entire sex toy can be illuminated by the lighting elements in accordance with the visual feedback indicator. In particular, the sex toy's illumination by the lighting elements can serve as the visual feedback indicator to a user.

Furthermore, one or more visual feedback indicators can be used on a single device. For instance, a sex toy can have a first visual feedback indicator on the bottom of the base of the sex toy and a second visual feedback indicator on the side of the sex toy so that the visual feedback indicators can be discerned from various viewing angles.

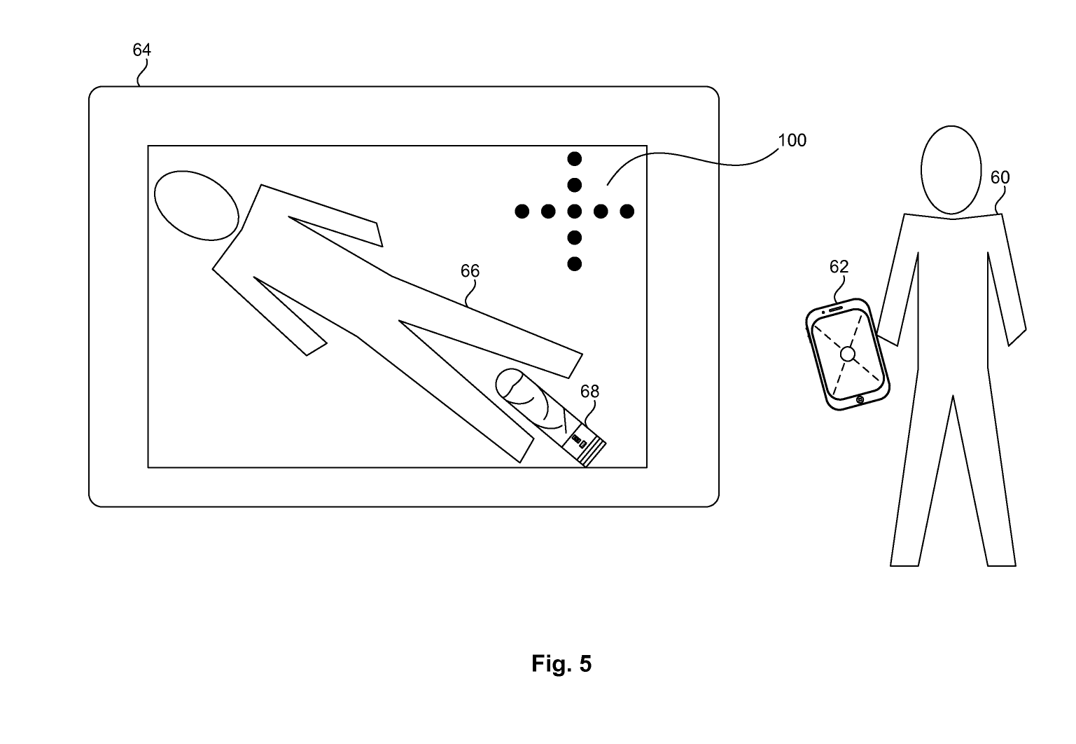

FIG. 5 illustrates a diagram of an interactive entertainment system for remotely operating a sex toy having a visual feedback indicator. The display device 64 can display a visual feedback indicator 100 on the screen of the display device 64. The visual feedback indicator 100 can be an array of LEDs (or icons, tiles, animations, background color, images, or any other visual indicator). The visual feedback indicator 100 can indicate to the user 60 the stimulation type, level, and patterns of the sex toy 68 in the interactive video. Thus, as the user 60 changes the stimulation (e.g., motion of the sex toy, force of the sex toy, vibrational strength of the sex toy, frequency of the sex toy, haptic pattern of the sex toy, other types of stimulations, and/or combinations thereof) of the sex toy 68 via the controller 62, the light pattern of the visual feedback indicator 100 will produce corresponding light patterns. Each light pattern can reflect the stimulation types, strength, and/or patterns of the sex toy 68. Furthermore, status information regarding the sex toy 68 can also be indicated via the visual feedback indicator 100. For instance, if the sex toy 68 is in an off state or idle state, a certain light pattern for the visual feedback indicator 100 can be displayed to reflect such state.

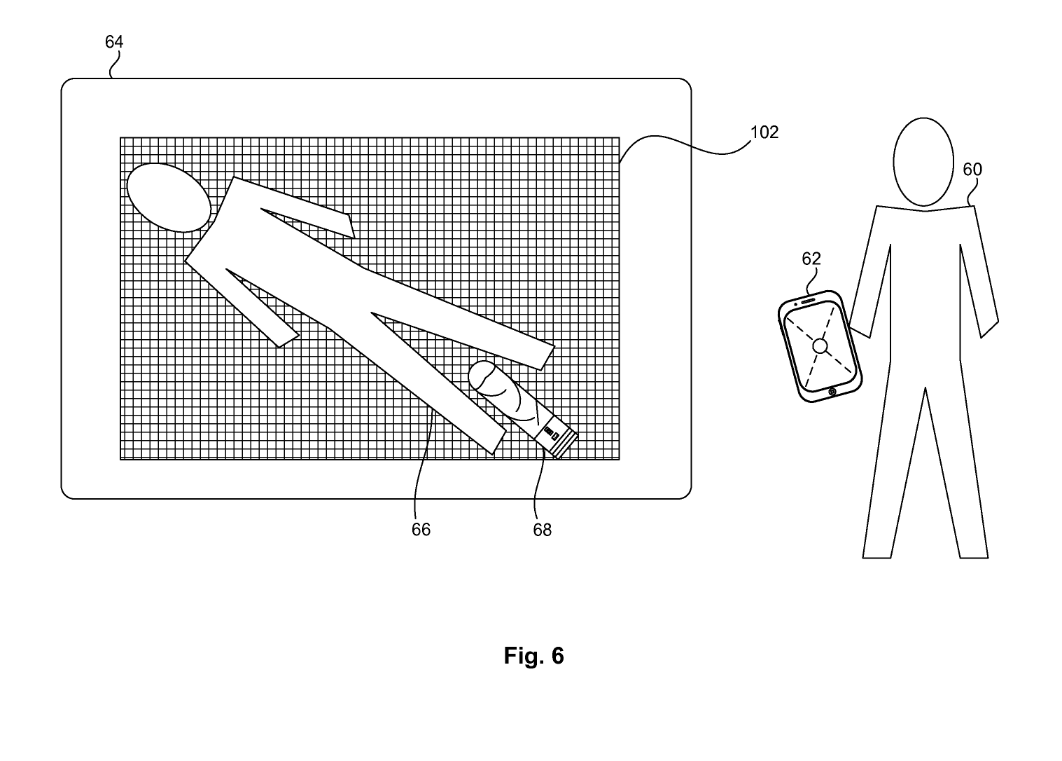

FIG. 6 illustrates another example of a diagram of an interactive entertainment system for remotely operating a sex toy, where a visual feedback indicator is provided. The display device 64 can also display a visual feedback indicator 102 on the screen of the display device 64. The visual feedback indicator 102 can be the background color around the user 66 (or some other visual indicator including artificial graphics, animations, or other indicators that can be around or overlap the user 66 and/or the sex toy 68). The visual feedback indicator 102 can indicate to the user 60 the stimulation levels and patterns of the sex toy 68 in the interactive video. Thus, as the user 60 changes the stimulation (e.g., vibrational strength, frequency, patterns, and/or other haptic feedback) of the sex toy 68 via the controller 62, the background color (or other visual indicator including graphics or animations) of the visual feedback indicator 102 will change as well to reflect that change. Each background color (or graphics/animation) can reflect the stimulation types, strength, and/or patterns of the sex toy 68. Furthermore, status information regarding the sex toy 68 can also be indicated via the visual feedback indicator 102. For instance, if the sex toy 68 is in an off state or idle state, a background color (or graphics/animation) for the visual feedback indicator 102 can be displayed to reflect such state.

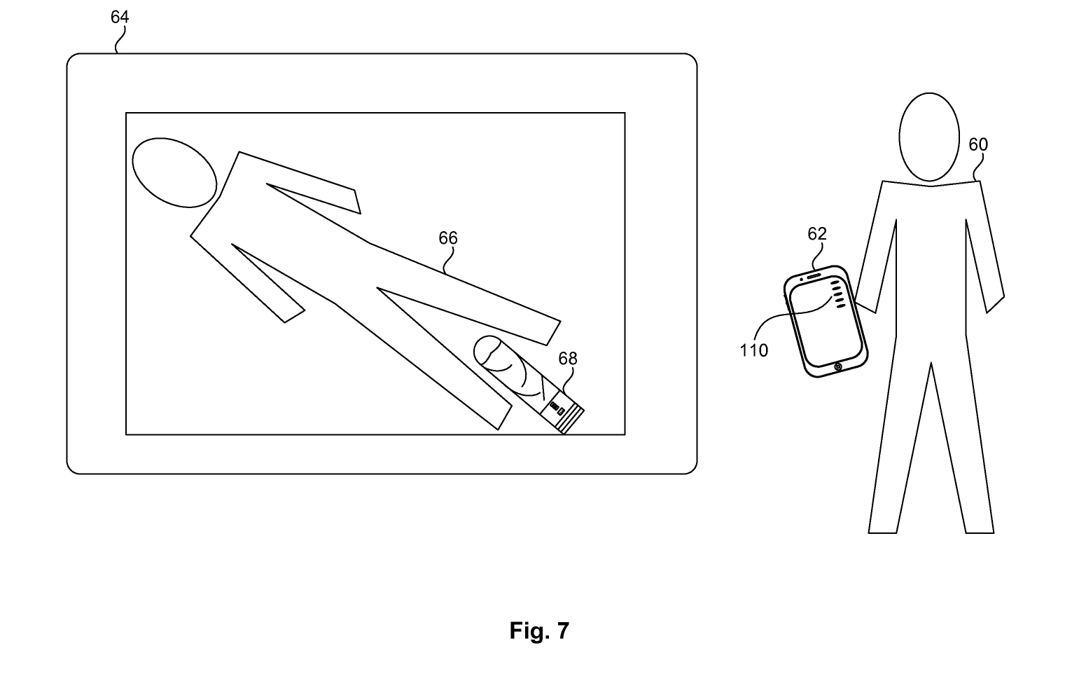

FIG. 7 illustrates yet another example of a diagram of an interactive entertainment system for remotely operating a sex toy, where a visual feedback indicator is provided. The controller 62 can also display a visual feedback indicator 110 on the screen of the controller 62. The visual feedback indicator 110 can be a displayed lighted pattern, indication bars, virtual light rays, artificial graphics, animations, the background color, or other visual indicator from the controller 62. The visual feedback indicator 110 can indicate to the user 60 the stimulation strength or pattern of the sex toy 68 in the interactive video. Thus, as the user 60 changes the stimulation (e.g., vibrational strength, frequency, patterns and/or other haptic feedback) of the sex toy 68 via the controller 62, the visual feedback indicator 110 will change as well to reflect that change. Each displayed lighted pattern, animation, background color, and/or other visual indicator can reflect the stimulation types, strength, and/or patterns of the sex toy 68. Furthermore, status information regarding the sex toy 68 can also be indicated via the visual feedback indicator 110. For instance, if the sex toy 68 is in an off state or idle state, a visual indicator for the visual feedback indicator 110 can be displayed to reflect such state.

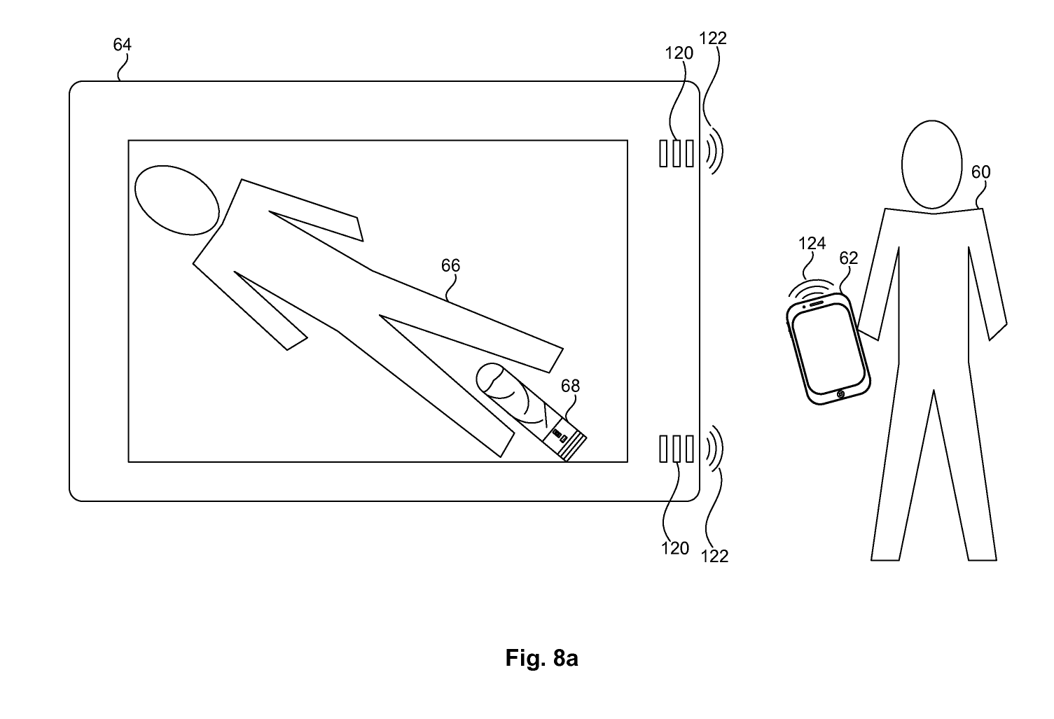

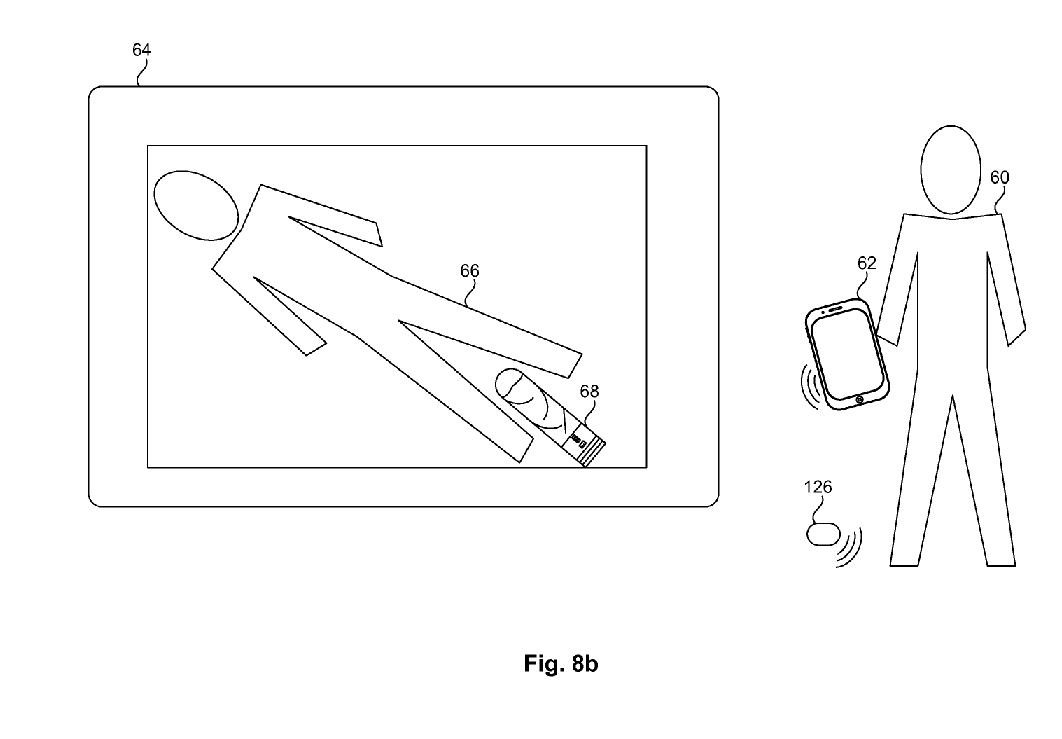

FIG. 8a illustrates a diagram of an interactive entertainment system for remotely operating a sex toy, where an audio feedback indicator is provided. In many cases, stimulations from the sex toy 68 are not loud enough for the user 60 to hear. Thus, additional audio feedback can be provided to the user 60 so that he/she knows the stimulation strength/patterns and/or status of the sex toy 68. The display device 64 and/or the controller 62 can provide an audio feedback indicator (e.g., audio sound 122 and/or audio sound 124) to indicate the stimulation (e.g., vibrational strength, frequency, patterns, and/or other haptic feedback) of the sex toy 68. The audio sound 122 can be played by speakers 120 of the display device 64. The audio sound 124 can be played by speakers 124 of the controller 62. Each audio tone or pattern can reflect the stimulation types, strength, and/or patterns of the sex toy 68. Furthermore, status information regarding the sex toy 68 can also be indicated via the audio sound 122 and/or audio sound 124. For instance, if the sex toy 68 is in an off state or idle state, an audio pattern can be played as an audio feedback indicator to reflect such state. Also, the audio feedback may also be provided to the user through other external speakers (not shown). The audio sounds 122 and 124 may mimic the vibrational sounds generated by a motor (or other sounds as desired, e.g., something that does not resemble a motor sound such as a ring tone or some other melody).

In other embodiments, if the sex toy 68 has one or more actuators, the audible pattern from the actuators can serve as a sensory feedback to the user 60. In such case, either actuators with loud audible sound are purposely picked, or other structures/features are added to amplify the sound from the actuators so that the user 60 can hear the audible pattern. The user 60 can either be physically present to hear the audible pattern of the actuators of the sex toy 68 or via the speakers of the display device 64 and/or the controller 62. Thereby, the audible pattern can indicate to the user 60 the stimulation strength/patterns and/or status of the sex toy 68.

FIG. 8b illustrates a diagram of an interactive entertainment system for remotely operating a sex toy, where a haptic feedback indicator is provided. In another example of an interactive entertainment system, the interactive entertainment system may further comprise a haptic device 126 for generating haptic feedback to a user 60. The haptic device 126 can be used to stimulate the user 60. In addition, either or both of the controller 62 and the haptic device 126 can provide a haptic feedback to indicate the stimulation strength/patterns and/or status of the sex toy 68. For instance, the vibration pattern and the status of the sex toy 68 can be fed back to the haptic device 126 and/or the controller 62. Thus, the vibration of the sex toy 68 can be rendered by an actuator of the controller 62 and/or be rendered by the haptic device 126. In this way, the user 60 can feel the vibration pattern and status of the sex toy 68.

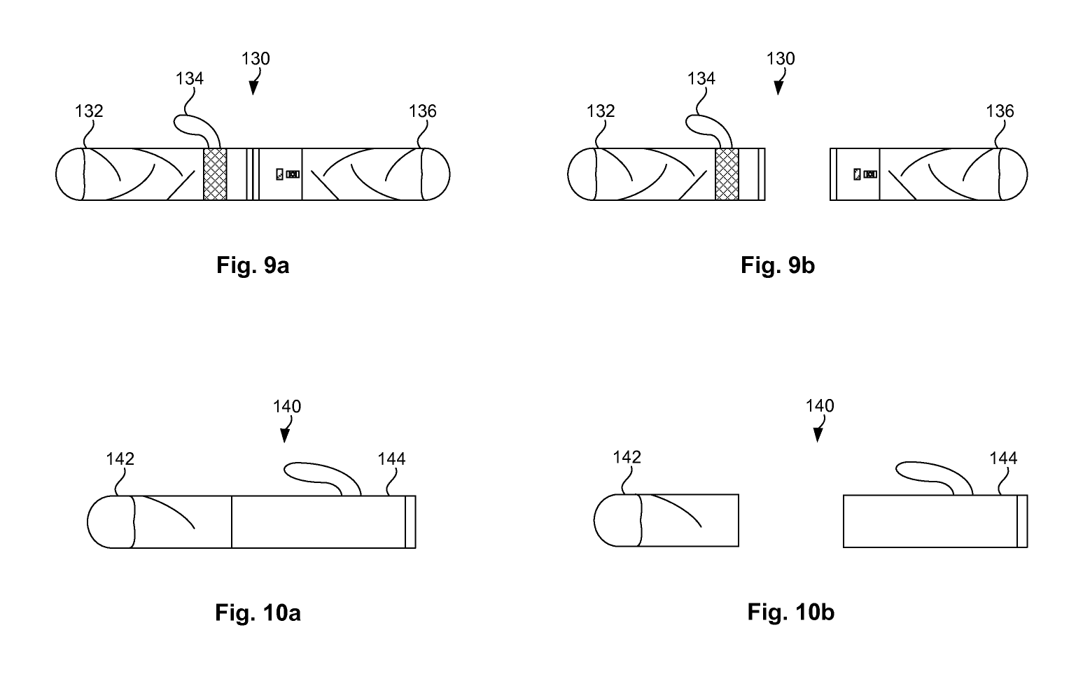

FIGS. 9a-15 illustrate diagrams of sex toys having modules. Referring to FIGS. 9a and 9b, a sex toy 130 comprises two modules 132 and 136 that can be coupled together, as shown in FIG. 9a, and uncoupled, as shown in FIG. 9b. Each of the modules 132 and 136 can be separately used as a sex toy. The module 132 can also have an arm 134 for specific area stimulation (e.g., clitoral stimulation).

Referring to FIGS. 10a-10b, a sex toy 140 comprises two modules 142 and 144 that can be coupled together, as shown in FIG. 10a, and uncoupled, as shown in FIG. 10b. Each of the modules 142 and 144 can be separately used as a sex toy (or not depending on the user's preference). For instance, module 142 can be used for vaginal stimulation and the module 144, which has an arm, can be used for clitoral stimulation.

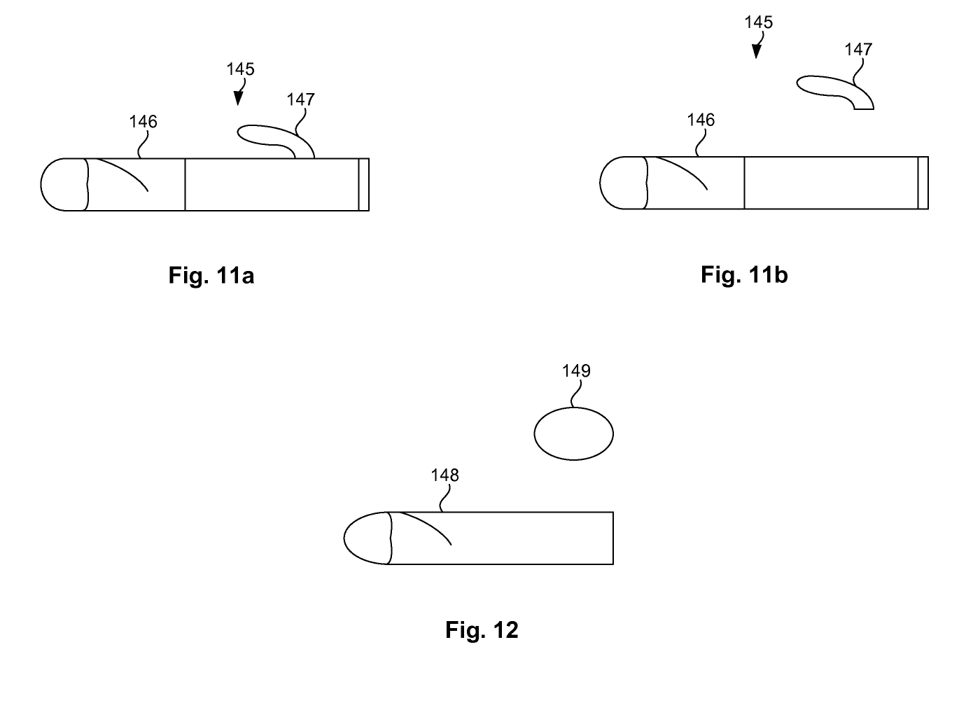

FIGS. 11a-11b illustrate diagrams of yet another embodiment of a sex toy having a detachable rabbit device. A sex toy 145 comprises a main body 146 and a vibrating rabbit device 147. The rabbit device 147 can be coupled to the main body 146, as shown in FIG. 11a, or decoupled from the main body 147, as shown in FIG. 11b. When decoupled, the main body 146 and the rabbit device 147 may have a wired or wireless connection to each other. The wired or wireless connection can allow the main body 146 and the decoupled rabbit device 147 to work in conjunction with each other.

FIG. 12 illustrates a sex toy having distinct devices. A sex toy can comprise two or more separate devices, e.g., a device 148 and a vibrational egg 149. The device 148 and the vibrational egg 149 may have a wired or wireless connection to each other. The wired or wireless connection can allow the device 148 and the vibrational egg 149 to work in conjunction with each other.

One or more visual feedback indicators can be provided on the device 148 and/or the vibrational egg 149 by having components that can produce light. In an example embodiment, the visual feedback indicator can be one or more lighting elements on the device 148 and/or the vibrational egg 149. The lighting elements can be lighted to indicate a vibration status and patterns of the device 148 and/or the vibrational egg 149. In alternative embodiments, the device 148 and/or the vibrational egg 149 can have one or more lighting elements in the device 148 and/or the vibrational egg 149 to light up part of the device or the entire device. Alternatively, the visual feedback indicator of the device 148 and/or the vibrational egg 149 can be located on a wire connected to the respective device.

For instance, if there is a wired connection between the device 148 and the vibrational egg 149, then the visual feedback indicator can be located on the wired connection. This can aid a viewer of the device 148 and the vibrational egg 149 since some users prefer to insert the device and/or vibrational egg 149 into a bodily cavity in which the respective device may no longer be externally viewable. However, by having the visual feedback indicator located on the wired connection, a viewer can still view the visual feedback regardless of the user inserting the device 148 and/or vibrational egg 149 into the bodily cavity.

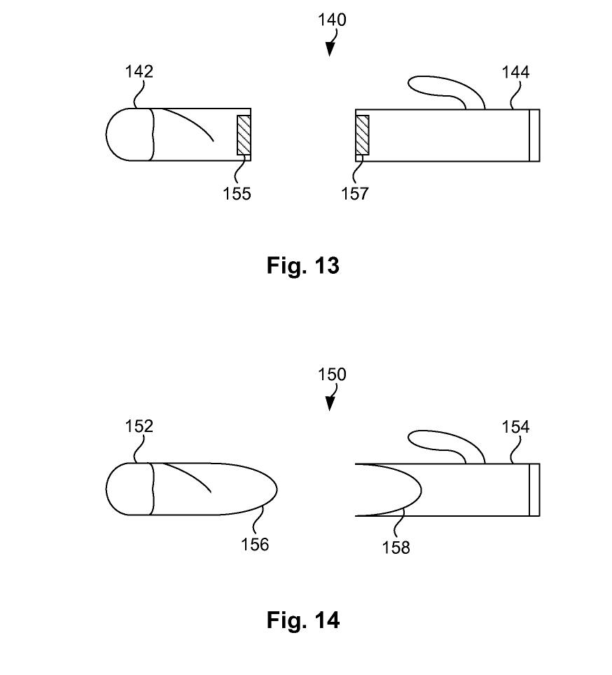

Coupling and decoupling of any modules of a sex toy can be performed by mechanical, electrical, adhesive, and/or other coupling and decoupling means. For instance, referring to FIG. 13, the module 142 of the sex toy 140 can have a magnet 155 and the module 144 of the sex toy 140 can have a magnet 157 (or other material attracted to magnets), where the magnets 155 and 157 can be coupled together and decoupled apart. When the magnets 155 and 157 are near each other, the magnetic forces from the magnets 155 and 157 can secure the modules 142 and 144 together.

The connected modules 142 and 144 can be separated (e.g., pulled apart) to be decoupled. The separated modules 142 and 144 can independently have their own haptic mechanisms. A user may use each of the modules 142 and 144 of the sex toy 140 as separate haptic generating devices.

Referring to FIG. 14, a sex toy 150 can have modules 152 and 154 coupled together or decoupled apart by having a mechanical force that connects the module 152 and 154 together. For instance, an end 156 of the module 152 can be inserted into an end 158 of the module 154 such that the end 158 applies a mechanical force (e.g., friction) onto the end 156 to keep the module 152 and module 154 secured together.

The connected modules 152 and 154 can be pulled apart to be decoupled. The separated modules 152 and 154 can independently have their own haptic mechanisms. Thus, a user may use each of the modules 152 and 154 of the sex toy 150 as separate haptic generating devices.

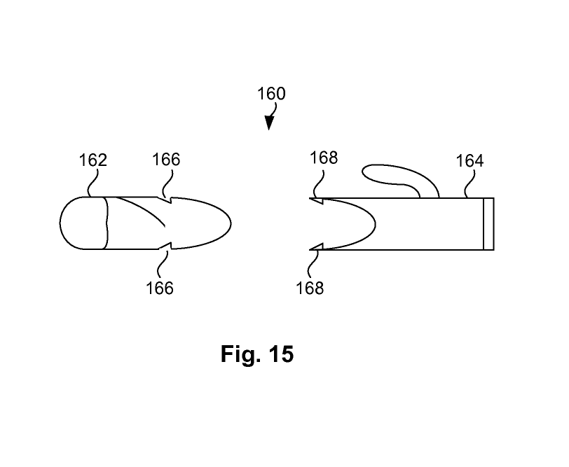

Referring to FIG. 15, a sex toy 160 can have modules 162 and 164 coupled together or decoupled apart by having a mechanical force with a hook that connects the module 162 and 164 together. For instance, hooks 168 of the module 164 can be inserted into indentations 166 of the module 162 such that the hooks 168 apply a mechanical force onto the indentations 166 to keep the module 162 and module 164 coupled together. The connected modules 162 and 164 can be separated (e.g., pulled apart) to be decoupled. The separated modules 162 and 164 can independently have their own haptic mechanisms. Thus, a user may use each of the modules 162 and 164 of the sex toy 160 as separate vibrating devices.

Furthermore, electric connections can be made between modules of a sex toy by various methods, including spring loaded surface contact connectors, metal connectors (e.g., electrical connectors for smart phone batteries), a multi-conductor cable (e.g., a phone jack, network cable, etc.).

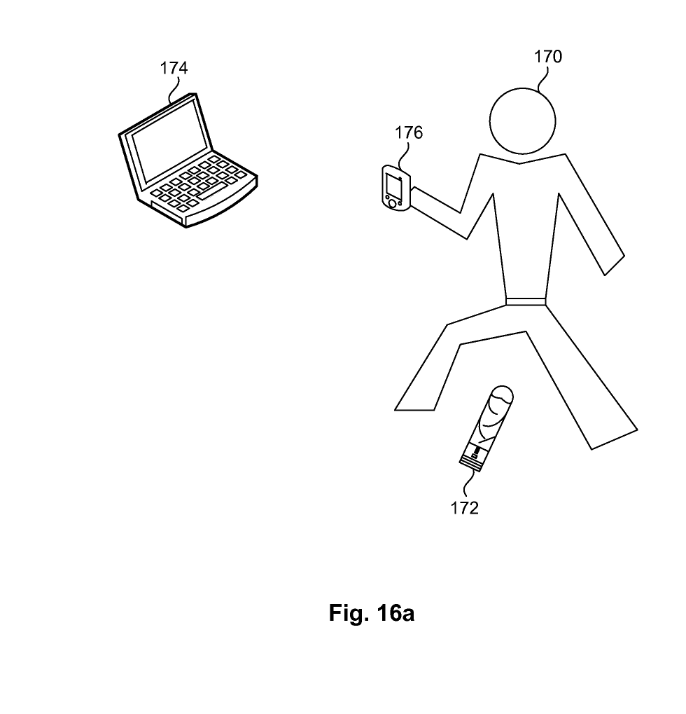

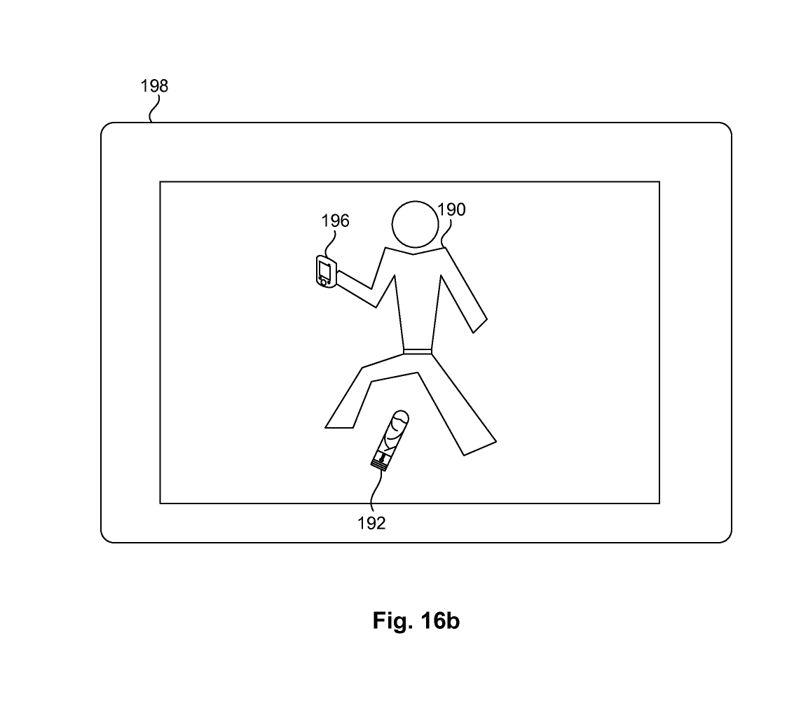

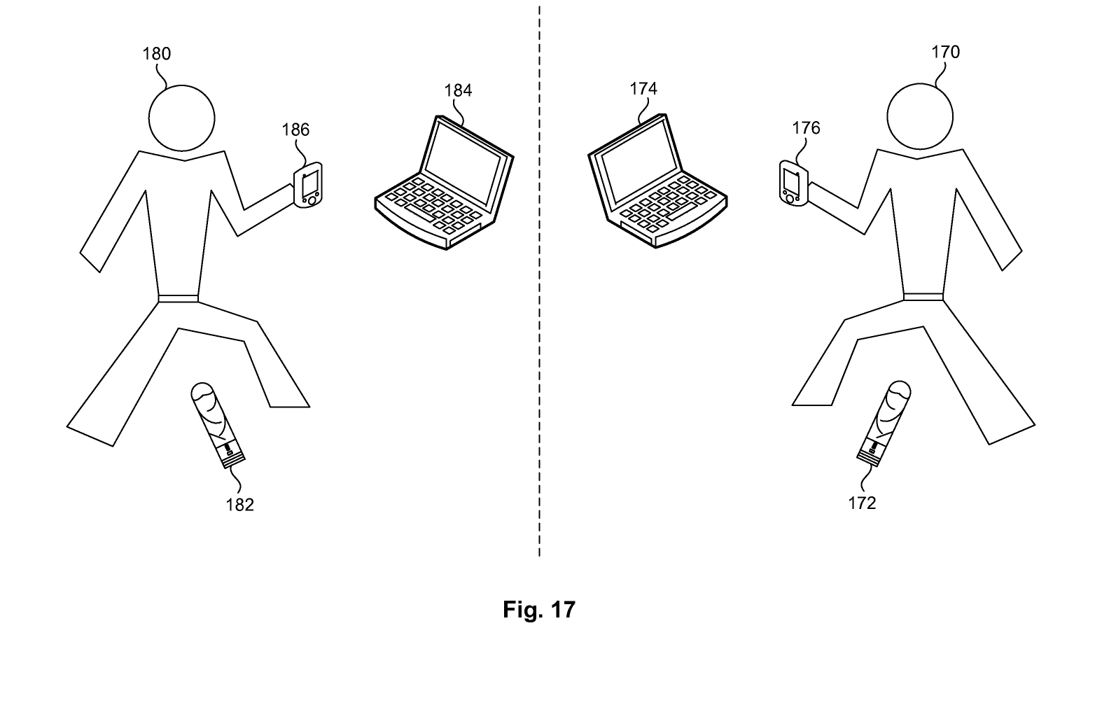

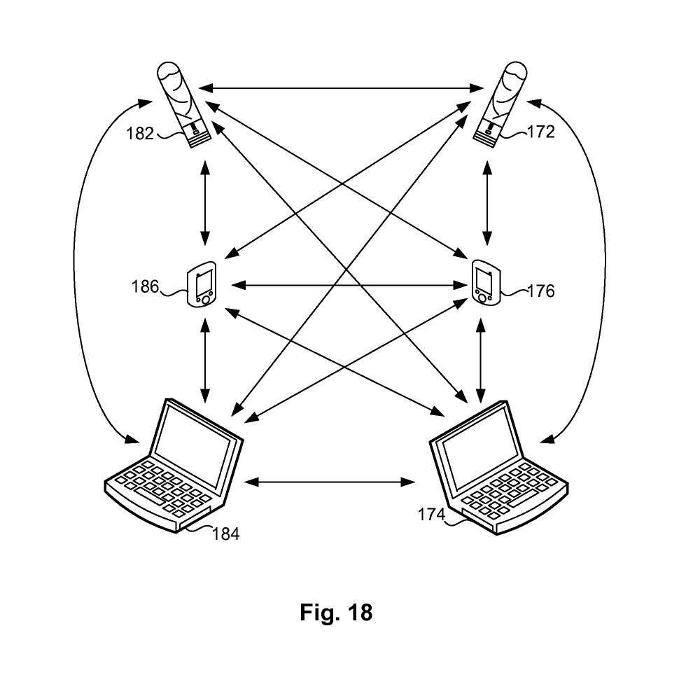

FIG. 16a illustrates a diagram of an interactive entertainment system for engaging in virtual sexual activity. An interactive entertainment system for engaging in virtual sexual activity comprises a sex toy 172, a display device 174, and a controller 176. A user 170 can view a virtual avatar on the display device 174 and interact with the virtual avatar via the controller 176. The virtual avatar can have a human-like personality. The interactive entertainment system can control the sex toy 172 to provide stimulations to the user 170. The stimulations can be personalized to the user 170 as a function of the user's 170 behavior (e.g., sounds, gestures, etc.) and the input to the controller 176. Each user may have a different experience, i.e., receive different stimulations, since each user may have different user behavior and input to the interactive entertainment system.

A wired or wireless data connection can be established between the sex toy 172 and the controller 176. A wired or wireless data connection can also be established between the controller 176 and the display device 174. Additionally, a wired or wireless connection can be established between the sex toy 172 and the display device 174. The sex toy 172's stimulation can be controlled by either the interactive entertainment system and/or the controller 176. Furthermore, it is appreciated the interactive entertainment system does not require all three data connections to operate. It is apparent to person having ordinary skill in the art that other communication topologies can be used to implement the present disclosure.

FIG. 16b illustrates a diagram of a display device of an interactive entertainment system for engaging in virtual sexual activity. A display device 198 of an interactive entertainment system displays a virtual environment having a virtual partner 190, a virtual controller 196, and a virtual sex toy 192. The virtual partner (also referred to as an “avatar”) can be created to interact with a physical user (not shown) of the interactive entertainment system. The avatar 190 can be displayed with the virtual controller 196 and the virtual sex toy 192 to mimic interaction with a real user.

Through virtualization software, the virtual avatar 190 can have a simulated personality to make its own decisions. For instance, the virtual avatar's responses may differ depending upon different stimuli it receives. Furthermore, physical users may also experience different responses from the same avatar during different play sessions.

An avatar's response to the physical user depends on the physical user's inputs to the interactive entertainment system, including the input to the controller's touch interface, voice, gestures, etc. The interactive entertainment system may take the physical user's input through sensors on the sex toy or the controller of the physical user. For example, such sensors may be implemented by, but not limited to, accelerometers, gyros, touch sensors, force sensors, microphones, and/or other sensory devices. An avatar may respond to the physical user's input that is sensed by the sensors in various ways, or combinations thereof.

In a first method, the avatar responds with sound or bodily motion, the nature of which depends upon the stimulation that the user sent to the avatar via input sensors on the physical user's device. For example, the volume of the avatar's voice response may vary directly with the strength of the vibration input to the avatar by the physical user. The body motion of an avatar which reflects different excitement level depends on the pattern of the haptic effects input to the avatar by the user.

In a second method, the avatar sends stimulation commands to the sex toy of the physical user to stimulate the physical user. For example, the stimulation commands that are received by the physical user may vary directly with the strength of the vibration input to the avatar by the user. Other methods can also be implemented based on the disclosure by a person having ordinary skill in the arts.

Avatars may be programmed with one or more predefined personalities. For example, an avatar that is programmed to be more outgoing may produce stronger stimulations for a given stimulus from a physical user compared to a less outgoing avatar. In an example, an avatar's personality can be characterized as a function of inputs from the user: (output1, output2, output3, output4 . . . )=f(input1, input2, input3, input 4, etc.). The outputs could be the avatar's voice volume, avatar's body motion, and/or haptic effect patterns that are sent back to the physical user. Furthermore, factors that determine stimulations can be vibration frequencies, amplitudes, effect lengths, number of cycles of vibrations, and so on for any devices used by the physical user.

In another example, an avatar's personality can be heuristically trained by a physical user. At first, the avatar responds to physical a user's input with a randomly generated haptic effect (e.g., a seed haptic effect), which the physical user may approve or disapprove of. The next time such an input is provided to the avatar, the avatar may change one or more parameters of the effect, such as the frequency of the vibration. The physical user then approves of disapproves of this change, and the heuristic algorithm in use uses the user's physical approval or disapproval to calculate a preferred effect based on the physical user's taste.

The virtual avatar's behavior can also be extracted from a real user's so that the extracted avatar of this real user can participate in sexual play with another real person. Because this extracted avatar's algorithm (e.g., the way the extracted avatar thinks) is based on the perceived user behavior, the extracted avatar of the user will tend to react the same way to the same type of interaction during play.

In a further example, a virtual avatar's audio personality profile is created to mimic a physical user. For instance, the physical user's pitch and duration of the physical user's aural response during stimulation by the physical user's sex toy can be sampled and stored. This sampling is performed many times with differing haptic effects to get more auditory sounds from the physical user. The sound recordings can be stored as scatter values of multivariate data. These sounds recordings can be used to create a virtual avatar based on the physical user.

Once a virtual avatar is created based on a physical user, another user can engage in sexual play with the virtual avatar. The interactive entertainment system may interpolate an audio response from the collected data set of the actual physical user.

In yet another example, two users engage in sexual play with each other via the system. The interactive entertainment system tracks the parameters of the stimulation that one user applies to another user as a response to a previous effect from the other. From this data, a catalog of high probability responses to user inputs can be built as personality profiles for use with avatars for each user is stored. The interactive entertainment system may present future stimulation responses emulating the real user's for someone else interacting with that user's avatar.

After users have played in the interactive entertainment system, each of the users can be assigned ranking scores according to his/her performance in the play. Performance can be defined by many different characteristics, such as time spent in each play, number of effects sent in each play, number of people played within a certain period of time, etc. The scores can then be shared with other users in the interactive entertainment system.

FIG. 17 illustrates a diagram of an interactive entertainment system for engaging in remote sexual activity with another user. An interactive entertainment system comprises sex toys 172 and 182, controllers 176 and 186, and display devices 174 and 184. The display devices 174 and 184, the controllers 176 and 186, and sex toys 172 and 182 can be interconnected via a network (e.g., the internet, a wired local area network, a wired wide area network, a wireless local area network, a wireless wide area network, etc.). Through this interconnection, the display devices 174 and 184, the controllers 176 and 186, and sex toys 172 and 182 can transmit commands and videos from one device to another device, depending on the capabilities of the respective device.

For instance, assuming the display devices 174 and 184 are laptops with video cameras and are interconnected via a computer network, then the display devices 174 and 184 can transmit recorded video to each other via the computer network. Furthermore, the controllers 176 and 186 can be smart phones that have network capability and can be further connected to a sex toy. As such, commands from the controller 186 can be routed through the computer network to the controller 176. The controller 176 can receive those commands, and further route the commands to the sex toy 172. Likewise, commands from the controllers 176 can be routed through the computer network to the controllers 186. The controller 186 can receive those commands from the computer network, and further route those commands to the sex toy 182.

Thus, the first user 170 can view a video of the second user 180 on the display device 174. The first user 170 can also control the second user's sex toy 182 via the controller 176. The first user 170 can also control his/her sex toy 172 as well. Also, the second user 180 can view a video of the first user 170 on the display device 184. The second user 180 can control the first user's sex toy 172 via the controller 186. The second user 180 can also control his/her sex toy 182.

In this manner, the first user 170 and the second user 180 can be in different locations and interact with each other by controlling each other's sex toys 172 and 182 and/or viewing each other on their respective display devices 174 and 184. In this setup, it is very difficult for the first user 170 to know exactly what effect he/she has selected for the sex toy 182 of the second user 180, and vice versa. A feedback indicator, using either haptic or non-haptic methods, can be indicated to the remotely located user to identify which command was selected for the sex toy of the other user.

One example is to feed back the effect to the controllers that the users are using. For the first user 170, the control/effect signal is fed back to controller 176. This feedback can be haptic, so that the same or similar vibration effect selected for the sex toy 182 is sent back to the controller 176. The first user 170 can feel the vibration pattern that he/she is selected for the second user 180. The feedback can be non-haptic as well. The haptic/vibration pattern can be mapped to graphic patterns, which are provided to the user as feedback. For example, the light patterns, light brightness, color of the background screen, and/or other visual indicator can be used to indicate the vibration strength on device 182.

Another example is to feed back the haptic effect (or other stimulation) sent to the other user to the sending user. For instance, the first user 170 sends a haptic effect command from controller 176 to the sex toy 182 through a computer network. The haptic effect command can also be sent to the first user's sex toy 172 as well. Thus, the sex toy 172 may get haptic effect commands from both controllers 186 and 176. The haptic effect commands from both controllers 186 and 176 can be combined to generate a combined haptic effect from the sex toy 172. The first user 170 is able to feel the effects sent from the second user 180 and the effects he or she have inputted. Likewise, the same can be said when the second user 180 sends haptic effect commands to the sex toy of the first user 170.

In alternative embodiments, one user may have control of both of the sex toys 172 and 182 at the same time. For instance, the first user 170 may have control of both of the sex toys 172 and 182 at the same time. Control can be switched over from one controller 176 to another controller 186, and vice versa. This can be referred to as a sharing mode. Basically, the first user 170 is sharing the effect that he/she is creating for the second user 180, and vice versa. In this case, the sex toys 172 and 182 should have roughly the same haptic effect (or other stimulation) that the first user 170 selected.

In another embodiment, a unidirectional remote sex activity with shared additional data information can be performed. In this manner, the second user 180 may only control the sex toy 172 and not have the sex toy 182 in operation. Thus, the commands for the sex toys are unidirectional, i.e., from the second user 180 to the first user's sex toy 172.

FIG. 18 illustrates a diagram for possible communication lines between various devices of an interactive entertainment system. As stated above, there can be a data connection between the display devices 174 and 184, the controllers 176 and 186, and the sex toys 172 and 182. The devices can be interconnected via a network (e.g., the internet, a wired local area network, a wired wide area network, a wireless local area network, a wireless wide area network, etc.). Through this interconnection, the display devices 174 and 184, the controllers 176 and 186, and sex toys 172 and 182 can transmit commands and video from one device to another device, depending on the capabilities of the respective device.

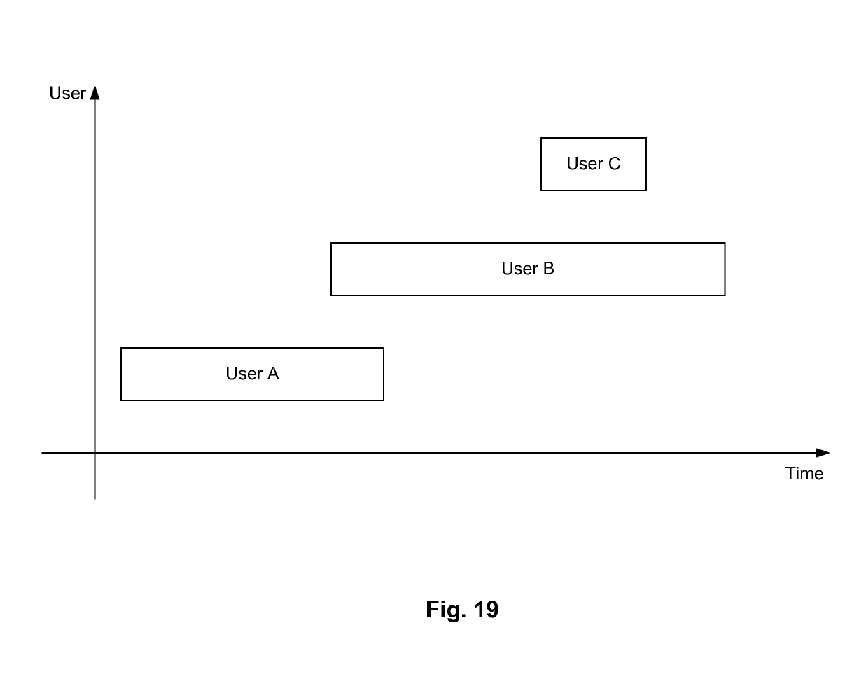

FIG. 19 illustrates a graph of user activity of an interactive entertainment system. A graph can be plotted having users versus login in time. When a session starts, a user can engage in an interactive entertainment system for an amount of time he/she desires. Multiple users can engage the interactive entertainment system simultaneously or at different times. For instance, user A can start a session first, then user B, and finally user C. User A's session overlaps with the user B's session; user B's session overlaps with user C's session; and user A's session does not overlap with user C's session.

Since the session of one user can be recorded and stored by the interactive entertainment system, the interaction of users can be time delayed and played back at a later time even if the session between users do not overlap. Thus, users of the interactive entertainment system can interact with each other at different points in time.

Furthermore, during a time delayed interaction session, the delayed user can be a virtual avatar based on a physical user. For instance, assuming user A is a real person and an avatar is established based on user B. The avatar of user B can also have a virtual sex toy and a virtual controller to use. In real life, user A and user B can be partners (e.g., husband and wife, girlfriend and boyfriend, etc.). However, they may not be synced time-wise in their sexual desire. For example, user A may want to engage in sexual play in the morning, while user B may not be present at that time. Thus, user A decides to engage in sexual play with user B's avatar in the system. The more user A uses the interactive entertainment system, the better we can refine an avatar for user A. Thus, when user B wants to engage in sexual play later and user A is not available, user B can then engage in sexual play with user A's avatar. In this way, users can not only engage in sexual play with each other from different locations, but can also engage in sexual play with each other via avatars at different points in time.

Avatars may also be generated to approximate the appearance and/or characteristics of real people, including movie stars, sports stars and audio-video (“AV”) stars, so that users can interact with these avatars.

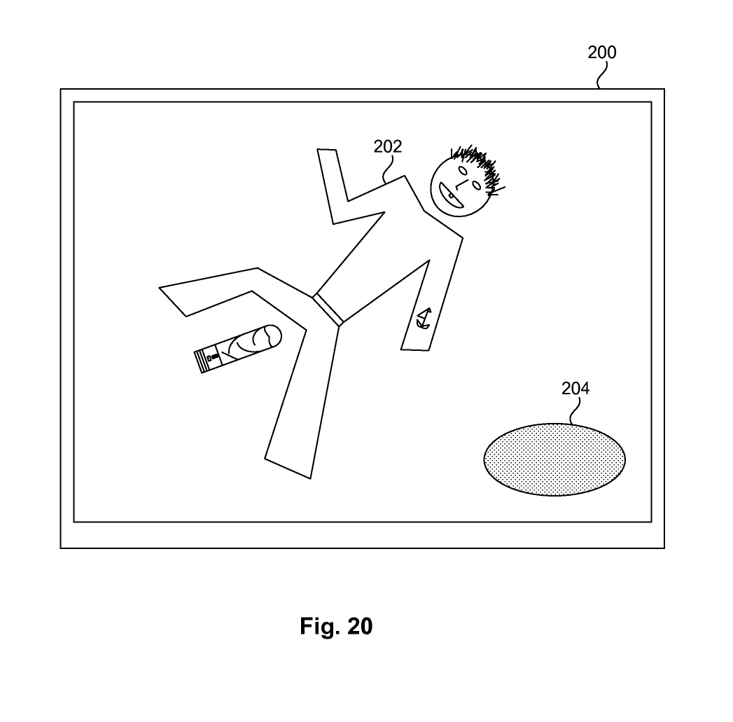

FIG. 20 illustrates a diagram of a device displaying an interactive video having a privacy control setting. An interactive video shown on a display device is an essential part of the remote sex activity of an interactive entertainment system. However, protecting privacy is also important during video remote sex activity. Therefore, a means to select one or more areas of the interactive entertainment system to blur, black out, or otherwise distort is provided.

Referring to FIG. 20, a display device 200 of an interactive entertainment system can display a user 202 engaging in sexual play and display a privacy indicator 204. First, the user 202 can select one or more areas on his/her persons and/or one or more areas elsewhere in the interactive video. For instance, the user 202 may want to blur areas that can be used to identity him/her or his/her place. The user 202 can select one or more non-identifiable areas as well in the interactive video for any reasons, including if the user may want to hide trash or any other non-appealing areas. The privacy indicator 204 displayed on the display device 200 can visually indicate the selected privacy setting of the user 202 to a remote user and to the user 202 if the user 202 previews the interactive video of himself or herself.

The privacy indicator 204 can be a pattern of LED lights, an animation, an icon, a color, a pattern, and/or any other visual indicator. For instance, if the privacy indicator 204 is a patch of green on the display device 200, then this can mean that the privacy settings are not set, meaning all areas of the interactive video are shown. If the privacy indicator 204 is a patch of red color on the display device 200, then this can mean that the privacy settings have been set by the user and that certain areas of the interactive video are shown are blurred or blacked out due to privacy settings.

A pattern recognition algorithm can be applied to track and blur those selected areas to protect the user's identity. For example, the selected areas can include the user's face, a certain part of user's body, a certain area of the room, a furniture item or other object within the video, and/or any other predefined area or environment. The blurring process can be processed on the user's device before sending out video data via a network connection to assure privacy protection. The transmitted video having the blurred areas can then be distributed online through the internet. Thus, even if the communication on the internet is hacked, the user does not need to worry about their privacy being leaked since the transmitted video has the preselected areas blurred for the user's protection. Users have the option to blur different areas (e.g., a small or large area) on the screen in order to achieve different levels of privacy protection.

In other embodiments, the blurring process can also be applied at other points in the data communications. For instance, blurring can be performed on a server that forwards a privacy protected video to another user for viewing. Furthermore, blurring can also be applied on the privacy protected video at the other user's device.

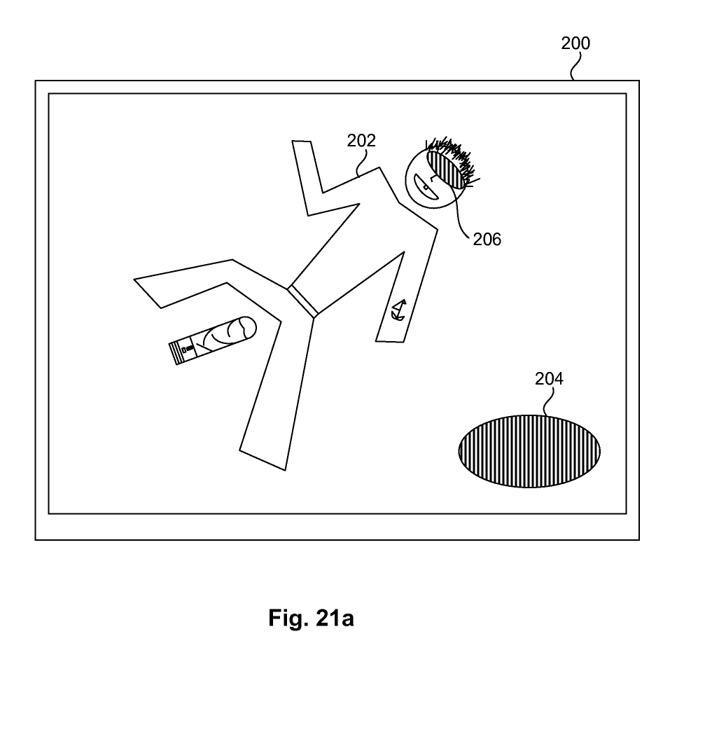

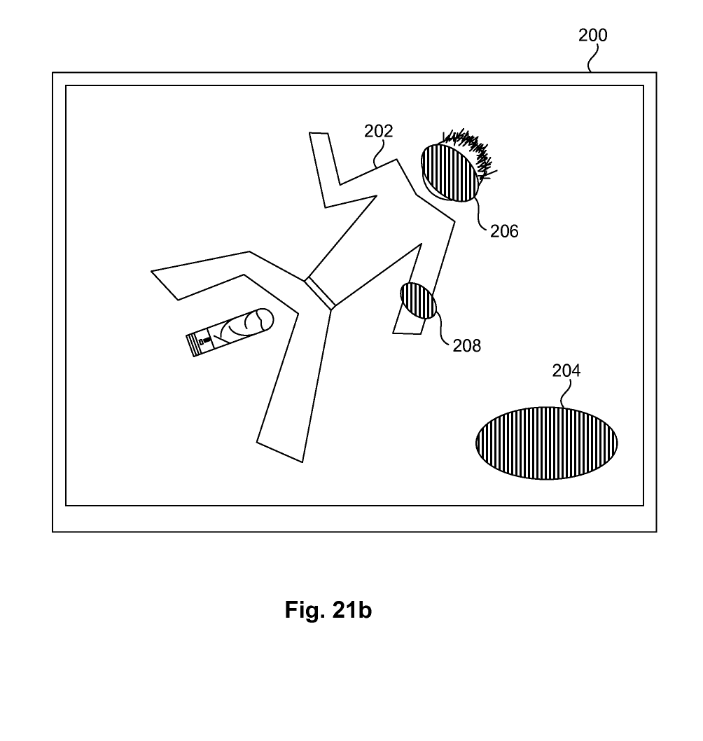

FIGS. 21a-21b illustrate diagrams of other examples of a device displaying an interactive video having a privacy control setting. In one example and referring to FIG. 21a, the user 202 can select to blur the upper portion of his/her face. The user 202 can first choose that area that he/she thinks might leak his/her identity on the screen. The interactive entertainment system can then blur that selected area throughout the remote sex activity of the user 202. An area 206 can be the blurred area of that selected area of the user. Furthermore, the privacy indicator 204 can be displayed on the display device 200 to indicate that a privacy setting has been engaged.

In another example, the user 202 may not need to choose any area of the interactive video on the display screen 200 to blur. The interactive entertainment system can automatically blur the user's face (and/or other predefined areas in the interactive video that can be determined using pattern recognition) so that the user's privacy is protected.

In another example and referring to FIG. 21b, the user 202 can select to blur multiple areas. The user 202 can select his/her face and his/her tattoo to blur. The interactive entertainment system can then blur those selected areas throughout the remote sex activity of the user 202. The area 206 can be the blurred area of the user's face. The user can select the size of the blurred area such that the user can select to not only blur out his/her eyes, but can blur out the entire face area as shown in the new area 206. Furthermore, the privacy indicator 204 can be displayed on the display device 200 to indicate that a privacy setting has been engaged.

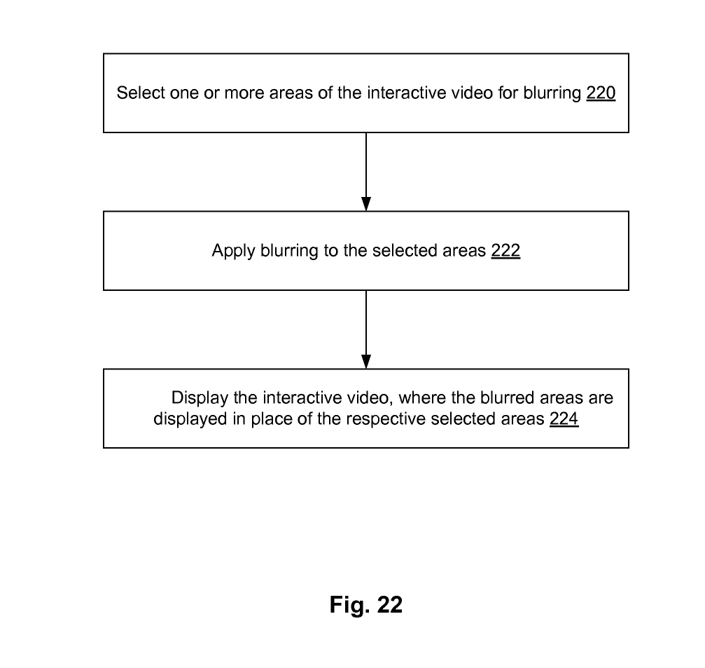

FIG. 22 illustrates a flow chart of determining a privacy control to apply to an interactive video. Privacy setting controls can allow a user of the interactive entertainment system to select which areas to show or not display of the user in a video. First, the user can select one or more areas that may be shown in the interactive video for blurring 220. For instance, the user may view what will be recorded on his/her side by viewing a preview of what is to be shown on the user's display device. During this preview, the user can select one or more areas to be blurred using his/her controller or display device. Once one or more areas are selected, those areas are blurred 222. Blurring can be processed on the user's side, e.g., by the display device, controller, other device used by the user to capture video on his/her side, or by another device that is used to upload video for distribution by the interactive entertainment system. The blurring can also be processed centrally by the interactive entertainment system elsewhere along the data communication route to a remote user, e.g., by a server that routes the interactive video, by the receiving user's device, or at some other point in the data communication. Once this interactive video is blurred, the interactive video is displayed at another user's display device 224, where the blurred areas are displayed in place of the respective selected areas.

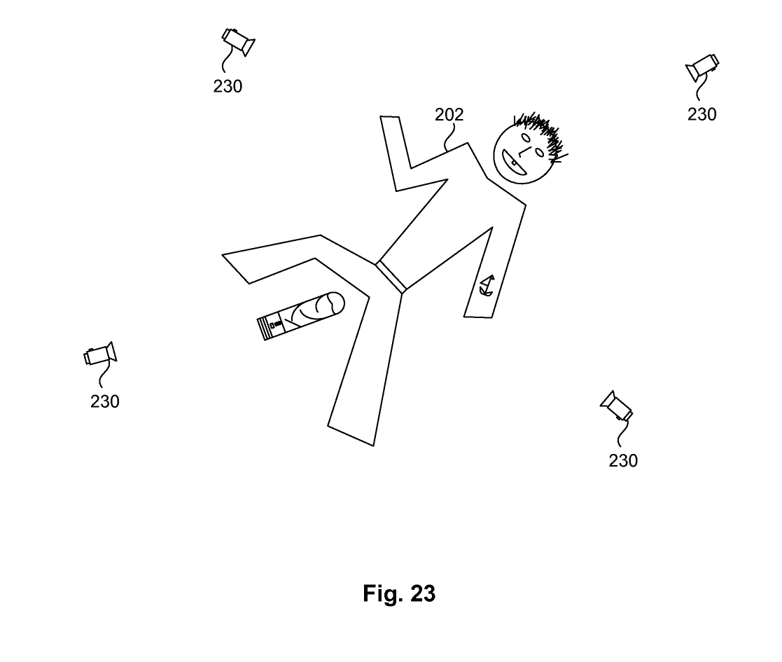

FIG. 23 illustrates a diagram of an interactive entertainment system having multiple cameras to record a user. A video of an interactive entertainment system can be generated using multiple camera angles of a user. For instance, a user 202 of the interactive entertainment system can film himself or herself using multiple cameras 230 to generate an interactive video with another user or with a virtual user. The cameras 230 can be IP cameras that are routed to the user's display device (or another user's device). The display device (or other user device) can further route the video having multiple angles to another user via a computer network. As such, more stable videos/images are obtained, and other users can get receive more than one viewing angle at the same time. All the active cameras can be wirelessly connected and can send video/images to the user's remote partners via a data connection (e.g., a network connection). The videos/images can be shown on a smartphone or a computer to the other user (e.g., his/her partner).

In other embodiments, the user 202 can use a controller (e.g., a smart phone) or a display device (e.g., a laptop) that has a camera to record video of himself or herself. Typically smartphones and laptops have at least one or two embedded cameras that allow for recording videos. In addition, the multiple cameras 230 can be paired with a user's smart phone and/or laptop to record video. In this manner, video data is sent to the smartphone or laptop from the video cameras. The smartphone or laptop can receive that video data and further process that data before being routed via a computer network to another user's display device.

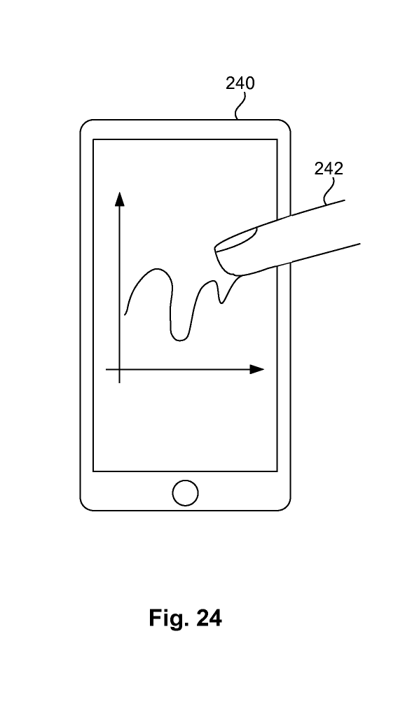

FIG. 24 illustrates a diagram of a controller having a graphical user interface to control a sex toy. Assuming for an interactive entertainment system that a controller of the user is paired, i.e., connected, with a sex toy (either the user's or remote partner's sex toy), the user's controller can have a graphical user interface to control that sex toy. In particular, the controller can be operated to select a command that is routed to the sex toy for selecting haptic stimulation. Thus, a graph shows a haptic stimulation profile displayed on controller, e.g., a mobile device. The user is enabled to use his/her fingers on a touchscreen of the controller to change any part of the haptic stimulation profile as desired.

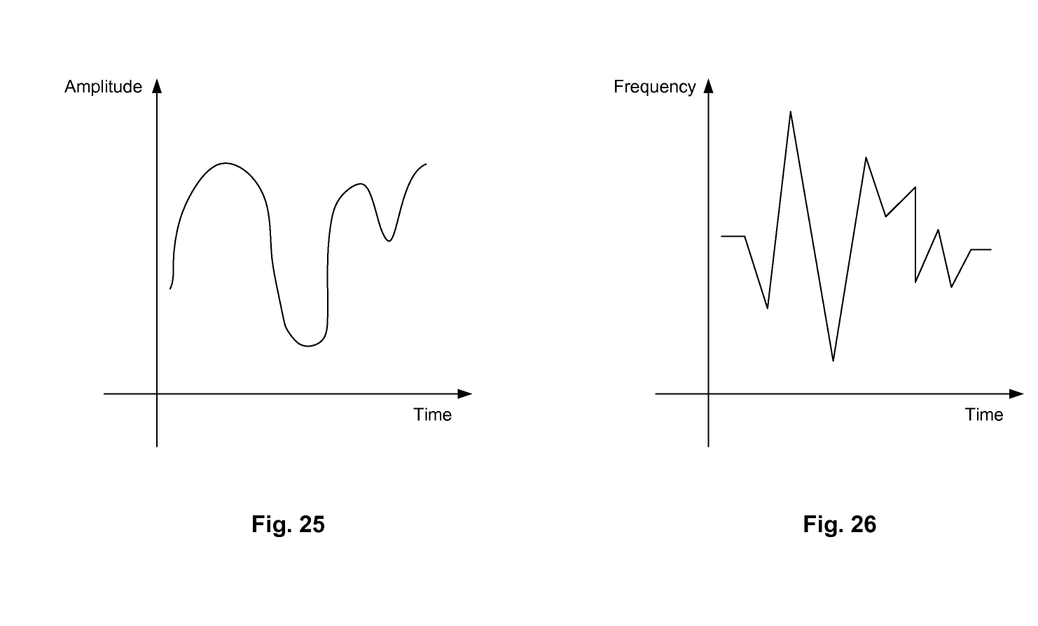

FIGS. 25-28 illustrate haptic stimulation graphs for a sex toy. The graphical user interface (“GUI”) for the controller of the user can be a graph in which the amplitude, frequency, time and/or combination of two or more (e.g., strength) of a sex toy can be directly inputted in the GUI. The GUI can be displayed on the controller of the user or other electronic device connected to the interactive entertainment system. The user can input/design a profile of the haptic stimulation of the sex toy using the GUI.

The sex toy can use one or more eccentric rotating mass (“ERM”) vibrators to provide haptic stimulation. In this case, the amplitude and the frequency can be coupled to each other. Thus only the amplitude or the frequency of the sex toy can be adjusted at the same time.

If a sex toy uses an actuator whose frequency and amplitude can be independently controlled, then the GUI can have separate graphs to control each. For instance, the user can input a vibration frequency profile to be applied to the sex toy, and then independently input a profile for the amplitude of the actuator of the sex toy.

Referring to FIG. 25, the GUI can be a graph of amplitude versus time. Assuming the controller has a touch screen with the graphical user interface displayed on it, then the user can use his/her finger to create a haptic stimulation profile for the sex toy. The time axis can be used to indicate the amount of time to set a certain amplitude level of the sex toy. The time units for the time axis can increase from the origin of the graph linearly, exponentially, or by another function. Likewise, the amplitude units for the amplitude axis can increase from the origin of the graph linearly, exponentially, or by another function. Once a user has inputted a profile to the GUI, the inputted profile can be stored so that the user can trigger this stimulus later in his/her remote sex activities.

Referring to FIG. 26, the GUI can be a graph of frequency versus time. Assuming the controller has a touch screen with the graphical user interface displayed on it, then the user can use his/her finger to create a haptic stimulation profile for the sex toy. The time axis can be used to indicate the amount of time to set a certain frequency level of the sex toy. The time units for the time axis can increase from the origin of the graph linearly, exponentially, or by another function. Likewise, the frequency units for the frequency axis can increase from the origin of the graph linearly, exponentially, or by another function. Once a user has inputted a profile to the GUI, the inputted profile is transmitted to a sex toy either via a network to a remotely located sex toy or to a local sex toy.

By having the ability to perform detailed editing of the frequency and amplitude of the one or more actuators of a sex toy in the time domain, users will have the ability to design a precise haptic effect. In particular, the users can edit the amplitude and frequency graphs (illustrated in FIGS. 25 and 26) to generate a stimulation profile.

In another example, a GUI having a simpler graph can be presented to adjust the frequency and amplitude at the same time, or use other adjustment paradigms. For instance, a strength unit that is a combination of an amplitude unit and frequency unit of the one or more actuators of the sex toy can be used. Thus, the user only needs to be concerned about the strength of the haptic feedback.

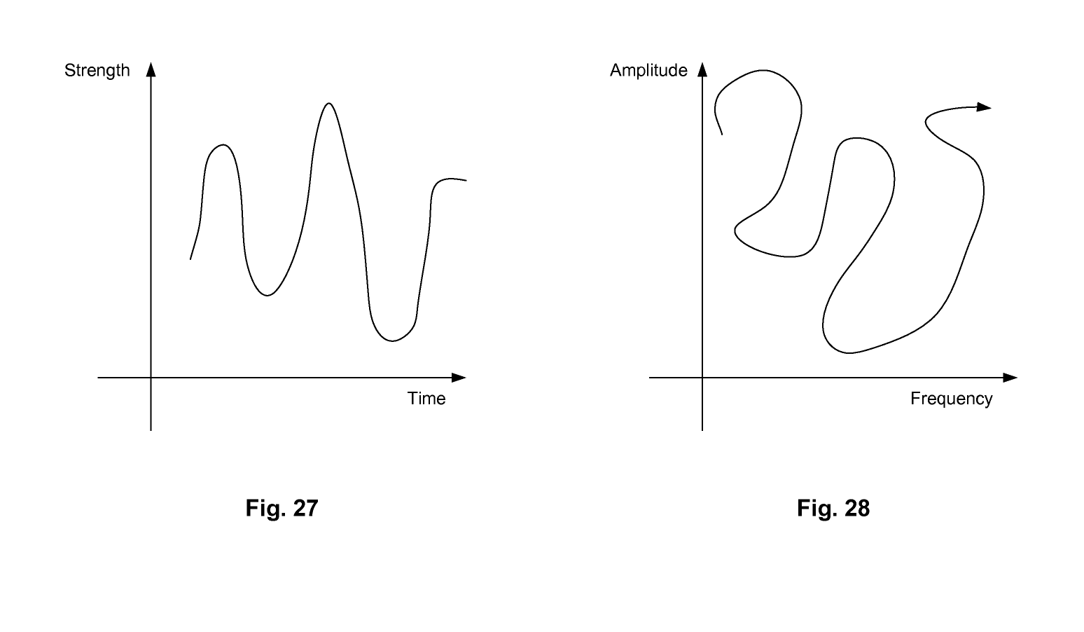

Referring to FIG. 27, the GUI can be a graph of strength versus time. Assuming the controller has a touch screen with the graphical user interface displayed on it, then the user can use his/her finger to create a haptic effect profile for the sex toy. The X axis represents the time and the Y axis represents the strength. A user can use this GUI to set the strength at any given time point, thus the user can design the haptic stimulus according to the strength very precisely. The time units for the time axis can increase from the origin of the graph linearly, exponentially, or by another function. Likewise, the strength units for the strength axis can increase from the origin of the graph linearly, exponentially, or by another function. Once a user has inputted a profile to the GUI, the inputted profile can be stored so that the user can trigger this stimulus later in his/her remote sex activities.

Referring to FIG. 28, the GUI can also display a graph of amplitude versus frequency for a user to input a haptic effect profile. Assuming the controller has a touch screen with the graphical user interface displayed on it, then the user can use his/her finger to create a haptic effect profile for the sex toy. The frequency units for the frequency axis can increase from the origin of the graph linearly, exponentially, or by another function. Likewise, the amplitude units for the amplitude axis can increase from the origin of the graph linearly, exponentially, or by another function. Once a user has inputted a profile to the GUI, the inputted profile is can be stored so that the user can trigger this stimulus later in his/her remote sex activities. The time length of the effect is defined by the length along the line in the profile. In this method, the user can adjust the amplitude and the frequency of the sex toy at the same time.

During online sexual activity with a remote partner, virtual sexual activity with an avatar, or self-stimulation activities, the ability to choose a background haptic effect set is provided. This effect set is played to the user or his/her partner while there are no inputs from the users to the devices as a baseline on which the users can add more effects, or as a stand-in for user-triggered effects during periods of no user input

In most interactions like this, effects are only initiated by users. Typically, no effects are present if there are no user inputs from the user. However, for sexual activities, it is important that the users not be overly distracted by having to constantly provide input to the system to produce effects. Therefore, automatic playback of a baseline set of effects, such as “background” effects may be desired. Thereby, users are engaged during periods of no remote user input. The users can also be enabled to choose different sets of background effects, as well as disable the feature. The system can also simple choose to repeat the last haptic effect instead of playing the “background” effect.

When haptic effects are triggered by the user (either remote user or local user), e.g., a user input, various methods can be used to account for background effects and user input. For instance, when there is user input, background effects are stopped and the interactive entertainment system only applies the haptic effects triggered by the user. Alternatively, if background effects are playing and user input received, background effects and the user-triggered effects can be combined together using a mapping method.

An example of a background effect can be a baseline heartbeat-like haptic effect that is continuously played by all devices connected to the interactive entertainment system. The baseline heartbeat-like haptic effect can provide to users of the interactive entertainment system with a minimal amount of stimulation, when there are no user inputs to the interactive entertainment system. When the users trigger effects, the user inputted effects are played back on top of the background heartbeat effect or the background heartbeat effect can stop and then the user inputted effects are then played.

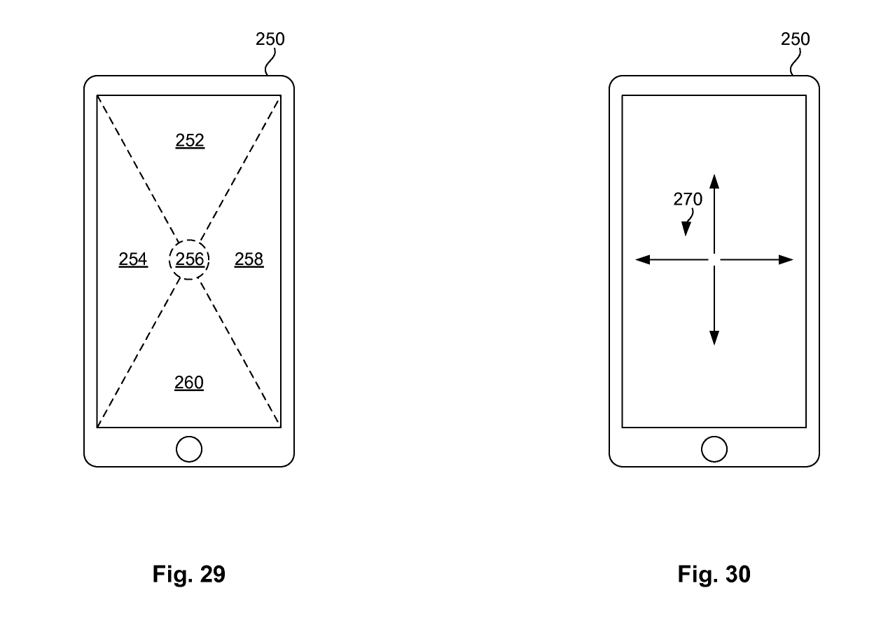

FIGS. 29-32 illustrate diagrams of controllers having various user interfaces for selecting haptic effects of a sex toy. A controller of the interactive entertainment system can be implemented using a smart mobile handset 250 to control the haptic effects of a sex toy (either a remote sex toy or a local sex toy). The smart mobile handset 250 can have a touch screen which can display a GUI for receiving input from the user to control the sex toy.

Referring to FIG. 29, the mobile handset 250 has a touchscreen user interface. A center area 256 can represent the center area of the touchscreen of the mobile handset 250. Areas 252, 254, 258, and 260 represent four areas located in four different regions relative to the center 256 area. When the user's finger is positioned on the area 256, the haptic effect (or other stimulations) that is associated with that area is played (or routed to other users if the user is involved in remote activities via the interactive entertainment system). The other areas 252, 254, 258, and 260 can have unique haptic effects associated with each area as well. The unique haptic effects can also be varied depending on the location of the touch input within the area, e.g., varying the effect strength for each unique response depending upon on the distance between the position of the touch input and a reference point, e.g., the area 256. For example, the strength of the haptic effect corresponding to the top part of 252 (furthest from the area 256) can be stronger than the strength of the effect corresponding to the bottom part of 252 (closest to the area 256), and so on for the other areas 254, 258, and 260.

The position of area 256 may be fixed, or may change depending on the GUI design. For example, the center area 256 can be assigned to any area on the touchscreen by having the user first touch the touchscreen for a predefined period of time at a certain area to set that certain area as the center area 256. Furthermore, that center area 256 can be reset by the user to a default position or to a user defined position on the touchscreen. The locations of the other areas can then be updated relative to the set location of the center area 256. The number of areas, size of areas, locations of areas that surround the center area 256 can also be different depending on the GUI design. In this example, there are four distinct areas, but there can be any number of areas around the center area.

Referring to FIG. 30, directional sliding motions 270 sensed on the touchscreen of the mobile handset 250 can be assigned to different haptic effects (or other stimulations). Each of the directional sliding motions can correspond to distinct haptic effects. Also, the length of the directional sliding motions can be used to determine the strength of the effect.

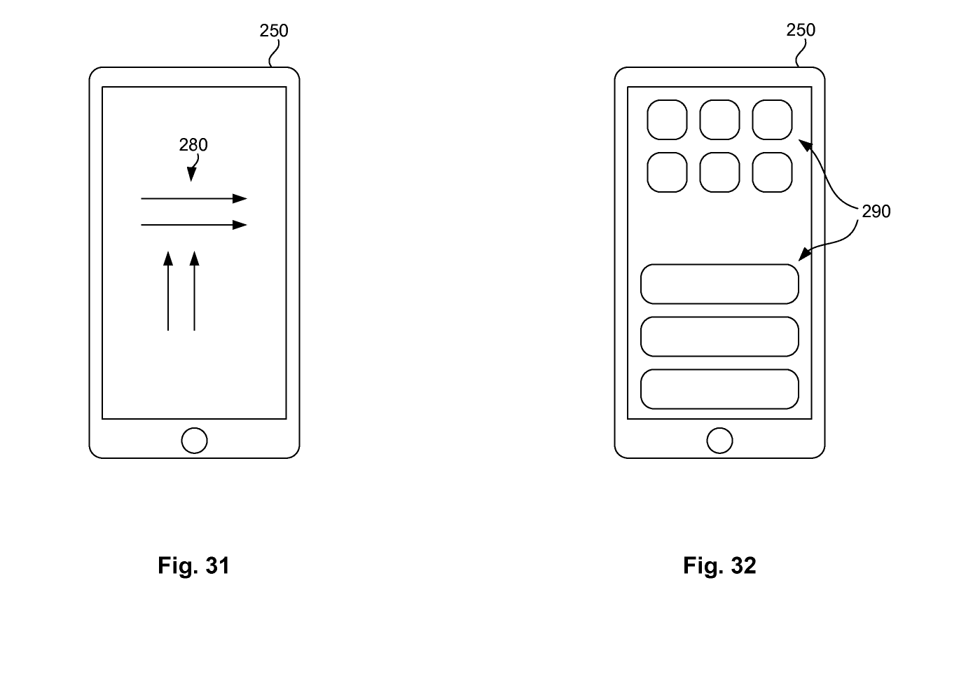

Referring to FIG. 31, a double slide or swipe (e.g., double slides 280) in a direction can also be used for further effects and/or to determine the intensity of the effects. Double slides in different directions can be assigned to distinct haptic effects. A double slide can be performed by consecutively sliding in one direction two or more times, or alternatively, simultaneously sliding two objects (e.g., two fingers) across the touch screen in the same direction. Other predefined gestures on the touchscreen can be used as well for triggering effects, e.g., such as pressing and clicking on the touchscreen.

Referring to FIG. 32, buttons 290 displayed on the touchscreen of the mobile handset 250 can be used to trigger different haptic effects (or other stimulations). By pressing on one of these buttons 290, a haptic effect is sent to control the haptic effect of the remote sex toy or the local sex toy. Each of the buttons 290 can correspond to different haptic effects. The buttons can be color coded to indicate the strength of the haptic effects. For example, a green button can indicate the weakest haptic effect, and a red button can indicate the strongest haptic effect. Some of the buttons 290 can be used to represent special haptic effect sets that are different from the other buttons. Other one of the buttons 290 can be a special button that can enable or stop the control of the haptic effect. Yet another button of the buttons 290 can be used by the user to switch between remote control and local control of the haptic feedback for his/her sex toy. For instance in a first mode, the user's sex toy is controlled by his/her remote partner. In a second mode, the user's sex toy is controlled by his/her handset. There can also be yet another button of the buttons 290 to stop remote sex play. Beside or in addition to the buttons 290, gestures can be used in combination of the buttons.

A user can select a type of input style for the mobile handset 250 for receiving user input. Thus, a user can customize the user interface on the mobile handset 250. For example, the size, shape, and the position of each button can be adjusted by the user.

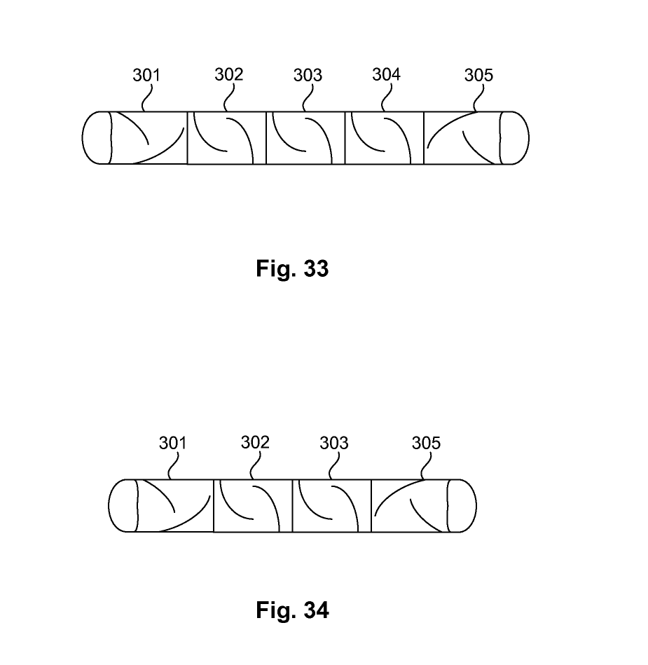

FIGS. 33-34 illustrate diagrams of modular sex toys. Each sex toy can comprise a number of individual modules, where the modules are connectable and disconnectable from each other. Each module may have different functions, including but not limited to haptic actuation, sound recording via microphones, and biometric thermal information with temperature sensors. The user chooses the types and number of modules suitable to their taste to construct a sex toy. For instance, if the user wants a twelve inch sex toy, the user can connect several modules together to have the desired length. This length can be increased and decreased as desired by connecting more modules or disconnecting existing modules from the sex toy. If the user wants only a one to three inch sex toy, the user may use a module individually as a sex toy.

The constructed sex toy can measure biometric information and generate haptic feedback based on the biometric information. The sex toy can have embedded sensors to measure biometric information of the user, such as blood pressure, blood oxygen level, heart rate, hardness of the penis, and excitement level of the user. Those parameters can be used by the system to decide what the most suitable haptic effect (or other stimulations) for the user in his/her current state.

Referring to FIG. 33, an example of a sex toy can comprise modules 301-305 that are connected together to form the sex toy. There can be five modules in this embodiment. Each module can comprise a cylindrical chassis with various functional components in it. The modules 301-305 are designed to connect end-to-end with each other on the circular faces with a hollow male thread on one end, and a female thread on the other for mechanical strength. In the end of a module with the hollow male thread, a 3-conductor phone plug rigidly mounted concentric to the thread provides outgoing electrical connectivity to the next module in the chain, with power, ground, and a single signal line being passed via the phone plug. In the end of a module with the female thread, a 3-conductor phone jack rigidly mounted concentric with the thread provides incoming electrical connectivity from the previous module in the chain. A face groove in the end of a module with the female thread with diameter greater than the thread but less than the overall diameter of the device, along with a ring seal in the groove, prevents the intrusion of foreign matter into the electrical connection, increasing reliability.

The module 305 can be a main control and power module containing in the chassis a secondary battery with its cells distributed around the axis of the chassis for providing power to the other modules, and a control board for controlling the various operating aspects of the device. The control board has a microcontroller present to manage communications and direct the other modules' activities. The control board also can have a bluetooth transceiver (or other wireless transceiver) for communications between the microcontroller and an external computing device such as a mobile device held by the user. An external barrel jack on the end of the module furthest from the other modules provides a location for input power from an external power source to recharge the internal power pack. An external microphone located near the barrel jack captures ambient sound to be recorded by the microcontroller. Finally, a pressure switch rigidly mounted to the chassis near the barrel jack allows the user to input some commands to the device, such as changing power states or starting and stopping communications. The circular face of module 305 closest to the module 304 houses the male thread with tip-ring-sleeve (“TRS”) plug for mechanical and electrical connectivity to the other modules. Communications to and from the module 305 occur over a single wire protocol on the signal connection in the TRS connected lines.

The module 304 can contain a temperature sensor for sensing ambient temperature to report to the microcontroller in the module 305 for use as biometric information to be fed back to the system as a user parameter used in the calculation of haptic effects or personality profiling. It passes power through the modules from the module 305 to the module 303, as well as injecting temperature data onto the signal line.

The module 303 can house an ERM coaxially in the center of its chassis and a high definition haptic actuator parallel to the chassis axis, as well as a microcontroller for decoding haptic commands from the main microcontroller in the module 305. The module 303 passes power and signals through itself from the module 304 to the module 302.

The modules 302 and 301 can each house an ERM coaxially in the center of their chassis. In addition, the module 301 can house a pressure sensor which senses force exerted on the outer surface of the module 301 by the vaginal walls for use as biometric information to be fed back to the system as a user parameter used in the calculation of haptic effects or personality profiling. The modules 302 and 301 each contain a microcontroller for decoding haptic commands from the main microcontroller in module 305.

Referring to FIG. 34, in a second configuration for the sex toy, the sex toy can comprise four modules, i.e., the modules 301, 302, 303, and 305. The sex toy can be substantially similar to the previous five segmented sex toy, but omits the temperature sensor module 304. The user may wish to have a shorter and lighter weight device, and may deem the temperature function unimportant. As before, power and control signals are passed from module to module via the TRS plug and jack arrangement. The main microcontroller in module 305 doesn't detect a temperature sensor present during enumeration, so disables that functionality in its firmware. The device otherwise operates as the previous one does, less temperature reporting. Thus, a sex toy can be composed of a different number of modules as desired or required by the user.

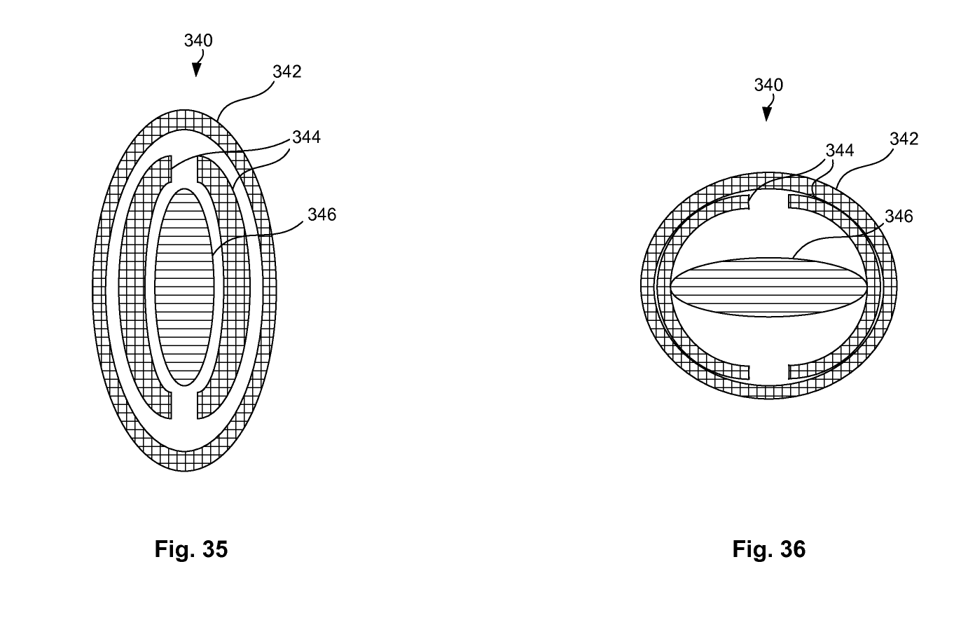

FIGS. 35-36 illustrate diagrams of cross sections of a sex toy. A sex toy 340 can be adjusted widthwise. If the sex toy has multiple modules, then one to all of the modules may also be adjustable widthwise as well. It is apparent to a person having ordinary skill in the art that the present disclosure can be applied to a single-bodied sex toy, a modular sex toy, and/or other variant of a sex toy.

The dimensions of sex toys can be important since different people have different size preferences. Some people might prefer a sex toy with a smaller diameter, while others may prefer larger diameter sex toys. The sex toy 340 can have an internal mechanism for changing the cross sectional width of the module.

For instance, the sex toy 340 can have an elastic cover 342, hard shells 344, and an oval center 346. The elastic cover 342 is disposed on the outside of the sex toy 340. The hard shells 344 can be expanded by rotating the oval center 346. When the oval center 346 between the hard shells 344 (see FIG. 35) in such a way that the outer edges of the oval center 346 are not pressed against the centers of the hard shells 34, then the sex toy 340 will have the least width diameter.

When the oval center 346 is rotated ninety degrees (see FIG. 36), the outer edges of the oval center 346 are wedged against the center of the hard shells 344, which in turn increases the diameter of the sex toy 340 to its largest diameter.

Various diameter sizes of the module can be found between these two states by keeping the oval center 346 between these states. Thus, the diameter of the sex toy 340 can be varied. A motor can be embedded in the sex toy 340 to rotate the oval center 346 to change the relative position of the oval center 346 to the hard shells 344.

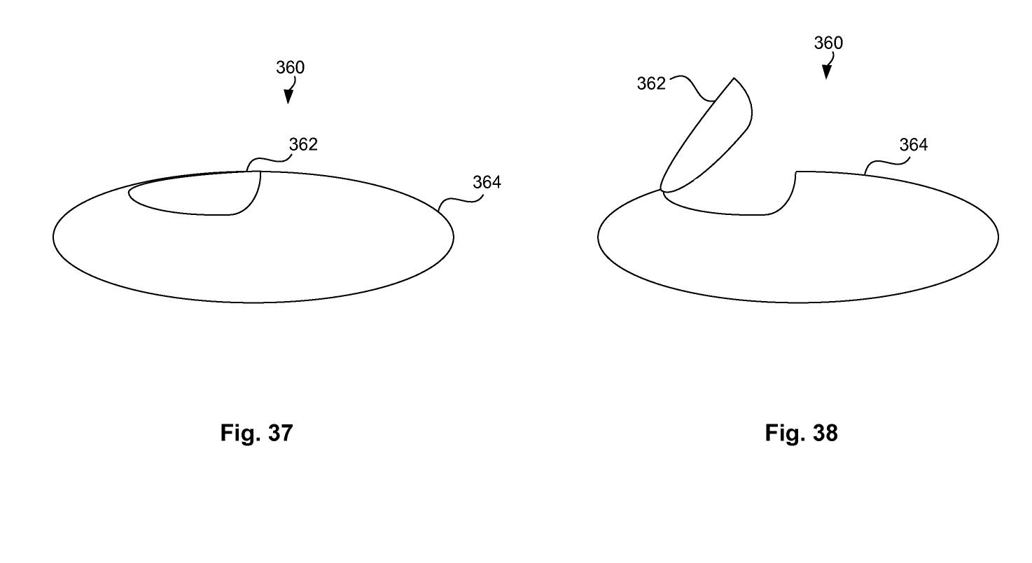

FIGS. 37-40 illustrate diagrams of convertible sex toys, where the sex toys can be converted to an alternate configuration. Referring to FIGS. 37 and 38, a sex toy 360 can convert to an alternate configuration in which its shape is altered depending on the user's need. For example, referring to FIG. 37, the sex toy 360 can have a main body 364 and a smaller body 362. The smaller body 362 can be lifted up away from the main body 364 (see FIG. 38) to stimulate a specific area of the user (e.g., the clitoris).

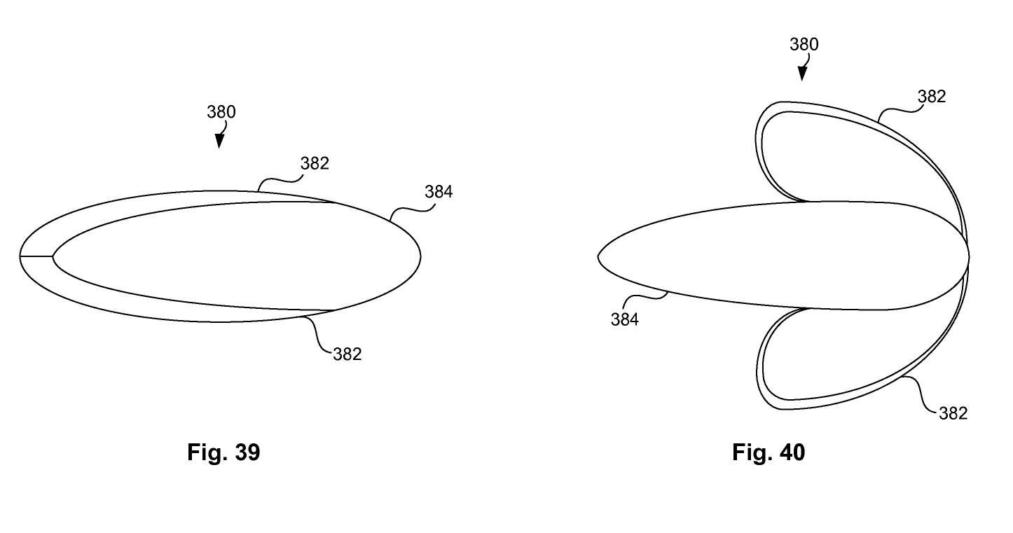

Referring to FIGS. 39-40, a sex toy 380 can have a main body 384 and an outer shell body 382. The outer shell body 382 can be peeled away from the main body 384 to change its shape (see FIG. 40).

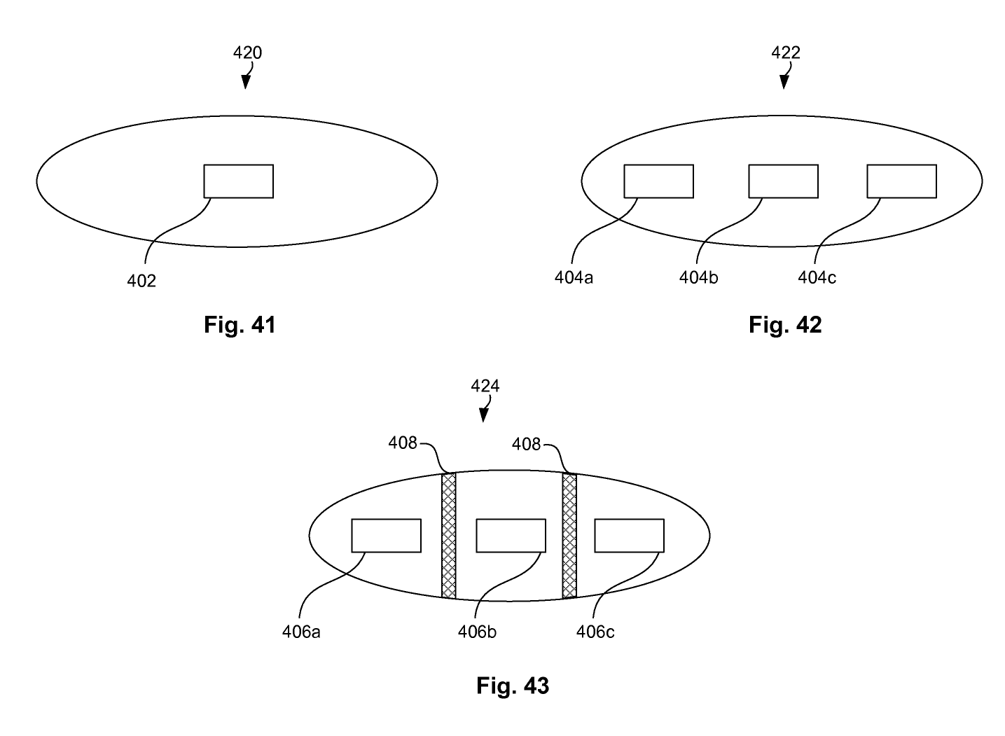

FIGS. 41-43 illustrate diagrams of sex toys having one or more actuators. A sex toy can have one or more actuators. By having multiple actuators, combinations of haptic patterns can be generated. Vibratory haptic effects can be generated by a sex toy using two or more actuators in the main body of the sex toy, and/or two or more actuators in a smaller/auxiliary body of the sex toy.

For example, referring to FIG. 41, a sex toy 420 comprises an actuator 402 that can generate combinations of haptic patterns. The actuator 402 may comprise multiple sub-actuators to generate the combinations of haptic patterns of the sex toy 420.

In another example, referring to FIG. 42, a sex toy 422 comprises actuators 404a, 404b, and 404c. By vibrating these actuators 404a-404c with different frequencies, amplitudes, and phases, combinations of haptic effects can be generated. Moreover, these actuators 404a-404c can be actuated one by one, or one group by another group, thus a sensation of directional motion can be generated. For example, if the motors are actuated in the sequence of left actuator to the right actuators, or vice versa, a sensation of “in and out” can be created by the sex toy 422 to the user.

In yet another example, referring to FIG. 43, to make the vibration from each actuator more independent, isolation materials 408 can be used in between each of the actuators 406a, 406b, and 406c of the sex toy 424.

Depending on the design goal, different materials can be chosen to achieve different hardness, thus different isolations can be achieved. For example, if a harder mechanical connection between a certain two of the actuators are desired, then a harder material can be placed between those two actuators. However, if a softer mechanical connection between another certain two of the actuators of the sex toy are also desired, then a softer material can be placed between those two actuators.

If two of the actuators 406a-406c are actuated at the same time, followed by another two of the actuators 406a-406c at the same time, a strong vibration with a feeling of an impact can be created. By doing different vibration combinations of the motors, many different stimulation patterns can be created. For example, if all three actuators 406a-406c are vibrated at the same time, then that can produce a very strong effect. If the three actuators 406a-406c are vibrated one by one in a sequence, a sensation of directional motion can be created.

Users have different preferences for length of sexual activity. Sometimes a user might prefer a short and quick orgasm, while at other times he/she might want a longer time to orgasm. By designing the stimulation pattern, the user can be provided with different stimulations that either can lead to a short time to orgasm or a longer time to orgasm. In an example, a time to orgasm can be selected to last twice as long as the standard time to orgasm. This selection may result in a stimulation that has 75% amplitude of the stimulation for the standard time to orgasm and 25% longer time between vibration cycles of the stimulation for the standard time to orgasm.

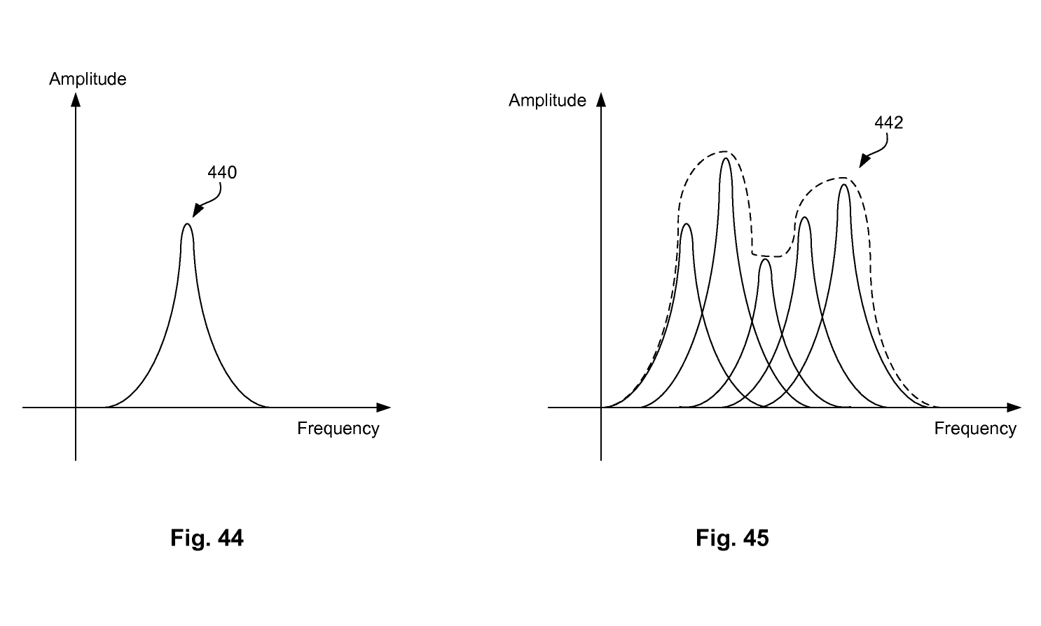

FIGS. 44-47 illustrate actuator control graphs for one or more actuators of the sex toys. Referring to FIG. 44, a curve 440 represents a frequency versus amplitude vibration characteristic of a specific linear resonant vibration actuator (“LRA”). An LRA usually has a very narrow bandwidth as shown in the above diagram (for instance 200 Hz+/−5 Hz). Using only one actuator in a sex toy can only create vibrations within a 10˜20 Hz band. If several vibration actuators are present that have different vibration characteristics in one sex toy, then a combined frequency/amplitude vibration characteristic map 442 can be created (see FIG. 45). Referring to FIG. 5, five LRAs with different resonant frequencies can be used. When the characteristics are combined, a vibration profile 442 is created, which has a much wider bandwidth than using a single LRA, e.g., LRA characteristic 440.

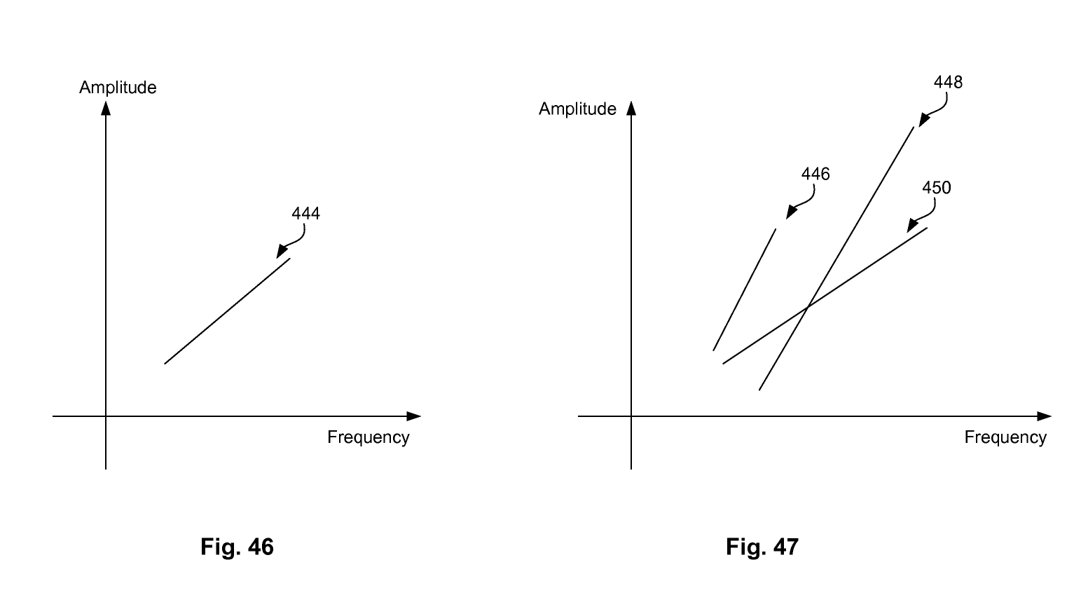

The same method can be applied to ERM (eccentric rotating mass) motors. The characteristic of each ERM motor can be represented by a line. Referring to FIG. 46, a line 444 represents the frequency amplitude characteristic of a specific ERM motors. If using only one ERM motor, a user can only create vibrations (with frequency and amplitudes) on that line 444.

However, by combining several motors with different characteristics together, you can create effects that are much richer. For instance, lines 446-450 represent frequency/amplitude characteristics of three different ERM motors. When combined together in one sex toy, the effect that a user can create is much richer (with respect to range in amplitude and/or frequency) than the effect of a sex toy with only one motor in it.

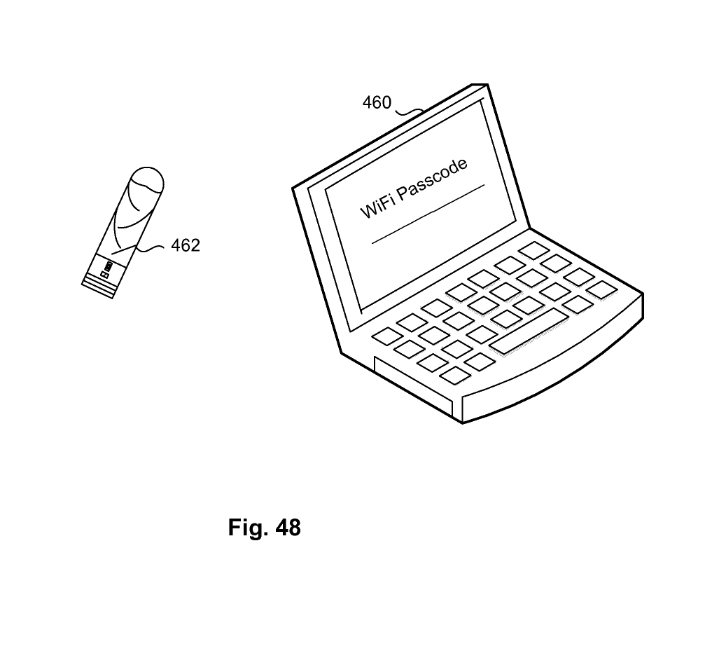

FIG. 48 illustrates a diagram of devices for an interactive entertainment system, where the devices are undergoing a setup phase. An interactive entertainment system on a user side can comprise a sex toy 462 and a laptop 460. Setup of Wi-Fi connections for devices used in the interactive entertainment system (such as web cameras, motion trackers, web thermometers, sex toys, etc.) can be difficult and time consuming and this process needs a wired connection. In many cases, users may have to connect the device to a computer to setup the Wi-Fi connection for the device. For instance, the sex toy 462 can be connected wirelessly to the laptop 460 for setup. The wireless connection can be by bluetooth, zigbee, or other wireless connection standard. The laptop 460 can take input from a user to setup the sex toy 462. In this way, users don't need to have a physical wire to connect the sex toy 462 to the laptop 460.

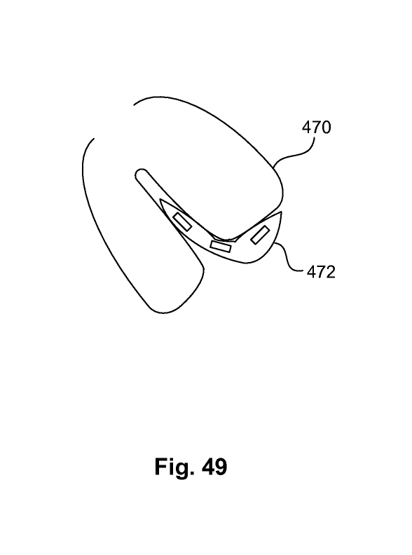

FIG. 49 illustrates a diagram of a cross sectional view of a vagina and a sex toy partially disposed in the vagina. In a unidirectional remote sex, which means that one user in control and another user is in the mode of receiving the effect from the controlling user. In this case, it is not necessary to have only two users. There can be a single user receiving effects from one or more other control users. It could also be many users that are receiving effects from the same control user. The users can be in a private space, such as bedrooms, or they could be in a public space.

For example, referring to FIG. 49, a wearable sex toy 472 is disposed in a vagina 470 of a female user. The female user can discretely wear the wearable sex toy 472. The female user can wear the sex toy 472 while she is doing her normal activities, such as shopping, dining, walking, etc. Furthermore, the wearable sex toy 472 can comprise multiple actuators to generate multiple haptic effects.

The wearable sex toy 472 may be connected with a data enabled smart device (e.g., smartphone, tablet, or other mobile smart device (not shown)) to transmit or receive commands for the wearable sex toy 472. The data enabled smart device can serve to route data to and from the sex toy and remote users. For instance, other people on the internet can control her sex toy 472 if she allows them to do so by having a connection between her data enabled smart device and the internet. One day she might want to allow ten people that she personally doesn't know to control her wearable sex toy 472 while she is shopping. She can also share some of her additional data in real time to those ten people to increase their excitement. Those additional data includes location data, walking speed data, temperature data, video, audio, etc. Vice versa, in some other situations, one person can be set to control several users' toys at the same time. The smartphone can receive or transmit that data or commands, and communicate that data and commands between the smart device and the wearable sex toy 472.

As long as the parties involved in online sex activities are at different locations, there can be latency in the information transfer. There are many different factors that affect the latency. For example, the rise time of the actuator, the communication latency between the sex toy with the mobile device/computer, the communication latency between the two users over long distances, and the system delay in the mobile phone/computer system. Once all the delays are added up, it can become too much for a good user experience.

A method of solving this issue is to extract information from the inputs of user A and send high level commands to user B instead of sending every piece of information from A to B. If accelerometers and gyros are used to capture the motion of user A, the detailed accelerometer and gyro data can be sent to the other user B in real time. However, this method can lead to latency delay.

If there is some delay in the system in the range that a user can discern but otherwise moderate (usually larger than 100 ms and less than 300 ms to 500 ms), the input data can be first processed to reduce the amount of data required to be sent over the data connection before being sent to user B to achieve a smaller delay.

If the delay in the system is too large (larger than 500 ms), then the system collects data until user A finishes his/her set of motions, and then processes the data which is sent as a high level command to user B. The high level command may comprise a message describing the drawing of a circle, or a hand shaking motion. The user experience of the interaction will also be changed in this case. User B is informed that he/she will only receive the feedback after user A finishes his/her set of motions.

For example, during the time user A is making a set of inputs on his mobile device, user B will get either a certain pattern of vibration or/and graphic indication on the GUI that user A is going to send something big (e.g., a large data set for commands). After user A is finished his/her input, the effect gets sent to user B and user B will get a set of effect train that was created by user A. In essence, the users can receive compressed combinations of user inputs instead of getting real time feedback.

While the disclosure has been described with reference to certain embodiments, it is to be understood that the disclosure is not limited to such embodiments. Rather, the disclosure should be understood and construed in its broadest meaning, as reflected by the following claims. Thus, these claims are to be understood as incorporating not only the apparatuses, methods, and systems described herein, but all those other and further alterations and modifications as would be apparent to those of ordinary skilled in the art.

We claim:

1. An interactive entertainment system, comprising:
a display device for viewing an interactive video; and
a controller for operating one or more sex toys for providing stimulations to a user at a remote location and displayed in the interactive video,
wherein a sensory feedback is generated as a function of the provided stimulations,
wherein the sensory feedback indicates one or more of the following: strength of the stimulations; patterns of the stimulations; characteristics of the stimulations; status of the stimulations; types of the stimulations; and the status of the sex toys, and
wherein the one or more sex toys and the controller are at different locations.

2. The interactive entertainment system of claim 1 wherein the sensory feedback is a visual feedback, and wherein the visual feedback is displayed on the one or more sex toys.

3. The interactive entertainment system of claim 1 wherein the sensory feedback is a visual feedback, and wherein the visual feedback is displayed on the display device.

4. The interactive entertainment system of claim 1 wherein the sensory feedback is a visual feedback, and wherein the visual feedback is displayed on the controller.

5. The interactive entertainment system of claim 1 further comprising an actuator, wherein the sensory feedback is a haptic stimulation pattern, and wherein the haptic stimulation pattern is applied to the actuator.

6. The interactive entertainment system of claim 1 further comprising a speaker, wherein the sensory feedback is an audio pattern, and wherein the audio pattern is played on the speaker.

7. The interactive entertainment system of claim 1 wherein at least one of the sex toys comprises one or more actuators and wherein the sensory feedback is an audible pattern generated by the actuators.

8. The interactive entertainment system of claim 1 wherein the one or more sex toys are virtual sex toys and wherein the user is a virtual user.

9. The interactive entertainment system of claim 1 wherein a certain one or more of the sex toys have a plurality of visual feedback indicators.

10. The interactive entertainment system of claim 1 wherein at least one of the sex toys has modular components and wherein the at least one of the sex toys is operated in a decoupled status.

11. The interactive entertainment system of claim 1 wherein at least one of the one or more sex toys are adjustable in width and length.

12. The interactive entertainment system of claim 1 wherein at least one of the sex toys is convertible to an alternate configuration.

13. The interactive entertainment system of claim 1 wherein at least one of the one or more sex toys has a plurality of distinct devices, and wherein the distinct devices are connected to each other via one of the following connections: a wired connection; and a wireless connection.

14. The interactive entertainment system of claim 1 wherein at least one of the sex toys comprises a plurality of actuators, and wherein the plurality of actuators operate in conjunction with each other to generate a range of stimulation effects.

15. The interactive entertainment system of claim 14 wherein the controller operates the one or more actuators using a graphical user interface, and wherein the graphical user interface is used to generate stimulations with various amplitudes, frequencies, patterns, and strengths of the one or more actuators.

16. The interactive entertainment system of claim 14 wherein the controller operates the one or more actuators using a non-graphical user interface, and wherein the non-graphical user interface is used to generate stimulations with various amplitudes, frequencies, patterns, and strengths of the one or more actuators.

17. The interactive entertainment system of claim 1 wherein one or more predefined areas in the interactive video are blurred.

18. The interactive entertainment system of claim 1 wherein the user is a virtual user, and wherein the virtual user is programmed to mimic responses and personalities of a physical user.

19. The interactive entertainment system of claim 18 wherein user preferences and user data of the physical user are recorded, and wherein the virtual user is generated as a function of the recorded user preferences and the user data.

20. A method for remote sex activity, comprising the steps of:
displaying an interactive video on a display device, wherein one or more sex toys are in the interactive video and wherein the one or more sex toys provide stimulations to a user;
operating the one or more sex toys using a controller, wherein stimulations are triggered by the controller; and
providing a sensory feedback as a function of the triggered stimulations,
wherein the one or more sex toys and the controller are at different locations, and
wherein the controller operates one or more actuators of the one or more sex toys.

21. The method for remote sex activity of claim 20 wherein the sensory feedback is one or more of the following:
a light pattern that is displayed on the display device;
a light pattern that is displayed on the one or more sex toys;
a light pattern that is displayed on the controller;
an audible pattern generated by the actuators of the one or more sex toys;
an audio pattern that is played by a speaker; and
a haptic pattern that is applied to an actuator.

22. The method for remote sex activity of claim 20 wherein, in the displaying step, further comprising the steps of:
selecting one or more areas of a scene in the interactive video;
blurring the selected areas; and
displaying the interactive video, wherein the blurred areas are displayed in place of the respective selected areas.

23. The method for remote sex activity of claim 20 wherein a virtual character is shown in the interactive video, and wherein the virtual character is programmed to mimic responses and personalities of a physical user of the interactive entertainment system.

24. The method for remote sex activity of claim 23 wherein user preferences and user data of the physical user are recorded, and wherein the virtual character is generated as a function of the recorded user preferences and the user data.

25. The method for remote sex activity of claim 20 wherein user data of a first physical user is recorded, and wherein the recorded user data is played back to a second physical user.

26. An interactive entertainment system, comprising:
a computing device having a display and a controller,
wherein an interactive video is displayed on the display,
wherein the controller operates one or more sex toys for providing stimulations to a user at a remote location and displayed in the interactive video,
wherein a sensory feedback is generated as a function of the provided stimulations,
wherein the sensory feedback indicates one or more of the following: strength of the stimulations; patterns of the stimulations; characteristics of the stimulations; status of the stimulations; types of the stimulations; and the status of the sex toys,
wherein the one or more sex toys and the computing device are at different locations,
wherein the sensory feedback is provided to a user of the computing device, and
wherein the sensory feedback is one or more of the following: a visual feedback; a haptic stimulation pattern; an audio pattern; and an audible pattern from the one or more sex toys.
